(19) United States
(12) Patent Application Publication
(10) Pub. No.: US 2015/0209898 A1
(43) Pub. Date: Jul. 30, 2015

(54) METHOD AND DICING DEVICE OF PROCESSING TRANSPARENT SPECIMEN USING ULTRAFAST PULSE LASER

(71) Applicant: KOREA ADVANCED INSTITUTE OF SCIENCE AND TECHNOLOGY, Daejeon (KR)

(72) Inventors: Seung Woo Kim, Daejeon (KR); Yun Seok Kim, Gwangju (KR); Sang Uk Park, Gyeongsangnam-do (KR); Joon Ho You, Daejeon (KR)

(73) Assignee: Korea Advanced Institute of Science and Technology, Yuseong-gu, Daejeon (KR)

(21) Appl. No.: 14/421,545

(22) PCT Filed: May 15, 2013
(86) PCT No.: PCT/KR2013/004305

§ 371 Date: Feb. 13, 2015

(30) Foreign Application Priority Data
Aug. 13, 2012 (KR) 10-2012-0088392
Mar. 29, 2013 (KR) 10-2013-0034212

(51) Int. Cl. B23K 26/00; C03B 33/09; B23K 26/06

(52) U.S. Cl. CPC B23K 26/0057; B23K 26/0045; B23K 26/0042; B23K 26/0036; B23K 26/0635; C03B 33/091

(57) ABSTRACT

A transparent specimen cutting method is provided using ultrafast laser and a dicing device for machining the transparent specimen. The cutting method includes forming a focal point by generating and focusing an ultrafast laser beam which has a pulse width of 10 fs-10 ps from a laser source and a center wavelength corresponding to the bandwidth of a transparent specimen, transmitting energy to the inside of the transparent specimen using the focused pulse laser beam by positioning the focal point of the pulse laser beam such that the focal point is positioned in an inner area on the inside of the both side surfaces of the transparent specimen, and generating and propagating cracks by relatively moving the focal point or the transparent specimen along a cut line in a desired shape such that cracks are propagated on the transparent specimen at a distance from the movement line of the focal point.

### CROSS-REFERENCE TO RELATED APPLICATIONS

The present application is a U.S. National Stage of International Patent Application No. PCT/KR2013/004305, filed on May 15, 2013 and published in Korea as WO2014/027738 on Feb. 20, 2014, and claims priority to Korean Patent Application No. 10-2012-0088392, filed on Aug. 13, 2012, and Korean Patent Application No. 10-2013-0034212, filed on Mar. 29, 2013, in the Korean Intellectual Property Office (KIPO), the disclosures of each of the applications noted above are incorporated by reference in their entirety herein.

### BACKGROUND

1. Technical Field

Example embodiments relate generally to a method of cutting or processing brittle transparent specimen material such as glass, strengthened glass, sapphire, silicon, etc. which has a relatively low absorption rate with respect to a central wavelength of an incident laser beam and a dicing device for implementing the method. More particularly example embodiments relate to a method of cutting or processing brittle transparent specimen as a desired shape by focusing an ultrafast pulse laser having a pulse width lower than 10 ps (picosecond) to the transparent specimen and a dicing device for implementing the method.

2. Discussion of the Related Art

Mechanical cutting methods and laser-based cutting methods such as scribing and blade dicing are used to cut and divide a brittle substrate of glass, silicon, ceramic, etc.

The conventional mechanical cutting methods have disadvantages that additional processes such as debris removal, washing, etc. are required after forming a plurality of chips, the residual stress is remained in the processed specimen to cause serious damage and tearing in case of a thin film under 100 μm, abrasion occurs in the processing tools through physical contacts of the tools and the specimen, the micro cracks remaining in the cut surface causes breakage of the specimen, and so on.

The laser-based cutting method may be divided largely into the two methods. The first method is to remove a portion of the specimen through phase change such as liquefaction, evaporation or plasma using a laser having a wavelength corresponding to the absorption band of the specimen to be cut. In this method, an amount of removal by the one-time illumination of the laser is limited and thus the deeper portions of the specimen are removed sequentially by the several scans. Accordingly the processing time is increased and a heat affected zone (HAZ) is formed widely around the processed portion to change material property, weaken the specimen by leaving residual stress and decrease uniformity of the specimen. The first method requires the additional process of removing the debris as the mechanical cutting method. Even though cutting may be performed through one-time scan by increasing the output of the laser, the bad influences of the output increase are similar to the above-mentioned disadvantages.

The second method based on laser is, instead of the removal of the specimen material, to generate and propagate a crack on the specimen to promote cutting or perform cutting directly. The laser is used to increase the temperature of the desired portion of the specimen and the crack is generated and propagated because the tensile stress is formed while the specimen is cooled.

The several methods using the above-described principles are developed and used in the industrial field. For example, there are thermal laser separation (TLS) dicing of Jenoptik Company and the dicing methods of Corning Company. These methods use the laser of the wavelength band that is absorbed by the specimen and cutting is performed through three processing steps. An initial crack is formed at an edge of the upper surface of the specimen, a laser is illuminated along a processing patter to cause a compression force and then a cooling system using aerosol or gas follows the laser to cause an abrupt tensile stress and develop the crack. The method has an advantage of excellence in the cut line or the cut surface, whereas the wide heat affected zone occurs due to the laser illuminated to the specimen.

As the second example, there is a multiple laser beam absorption method of Rofin Company. This method uses, as a light source, a continuous wave (CW) laser or a disc laser having a wavelength band that is penetrated by the specimen. It is difficult to heat the specimen when the central wavelength of the laser is not absorbed by the specimen. To overcome the difficulty, the method illuminates the laser to the specimen with maintaining the output of the laser to several watts and the diameter of the laser beam to several millimeters so that the multiple reflections may occur in the specimen to keep the heat absorption. This method has advantages of the sufficient tensile stress without the additional cooling system after the laser illumination and possibility of forming cut lines of a straight line and a curved line, while thermal transform of the specimen may be caused due to the high output of the laser and it cannot be used when other materials are coated near the cut line on the surface of the specimen.

As the last example, there is a stealth dicing method of Hamamatsu Company. This method uses, as a light source, a laser having a wavelength band that is penetrated by the specimen. Cutting is performed by focusing the laser inside the specimen along a line to be cut to generate and grow reforming and crack in the specimen. The method has an advantage of excellence in the cut line, but the processing of the curved line is impossible and additional cracks may be developed in arbitrary directions when a certain weight is imposed and thus applicable area is limited because the reformed surface is exposed as a cut surface.

Recently the ultrafast pulse laser having a pulse width under picosecond is in the spotlight of the industrial field in addition to the research field.

The ultrafast pulse laser has a pulse width between several femtoseconds and several picoseconds that is oscillating in a pulse form by arranging a phase through mode locking among a plurality of frequency modes in a laser resonator. The ultrafast pulse laser may be implemented through various amplifying media. For example, the ultrafast pulse laser may include a bulk-type laser of the central wavelength of 780 nm using Ti:Sapphire as the amplifying media and a laser based on an optical fiber having additives of ER or Yb ions of the central wavelength of 1550 nm or 1040 nm.

In case of the Ti:Sapphire ultrafast pulse laser, the most optical path of the laser resonator is formed of air to facilitate a pulse spread control and a narrow pulse of several femtoseconds may be generated because the emission spectrum of the amplifying media is wide. In contrast, the amplifying system increases the size of the entire system, it is difficult to increase the average output and the repetition rate is limited to a few hundred KHz because of sensitiveness to environmental change and the thermal loss of the amplifying media. In case of the ultrafast laser based on the optical fiber, the most optical path is formed of the optical fiber and thus it is difficult to obtain the narrow pulse width of the bulk type ultrafast pulse laser. This laser may have the pulse width of about 100 fs but it has advantages of insensitiveness to the environmental change, a small size, easy maintenance. The high average output over several watts and the high repetition rate over several MHz may be implemented easily due to excellent heat characteristics of the optical fiber itself. For example, the high repetition rate is required when the velocity of the processed object on the stage is relatively fast and the curved process is required. In this case, the high repetition rate of the ultrafast pulse laser based on the optical fiber is favorable.

The very high peak output over 1012 W/cm2 may be obtained easily with the spatial concentration using a proper object lens because the most oscillating energy of such ultrafast pulse laser is concentrated in a narrow pulse width range of several fs through several ps. The high peak output and the narrow pulse width under several ps may cause various nonlinear phenomena. Particularly the absorption rate may be increased significantly due to multiple photon absorption and avalanche ionization when focusing the laser in the transparent specimen and the laser energy may be transferred efficiently to the inside of the transparent specimen.

The reaction process between the laser and the material may be represented by several physical phenomena according to time scale as illustrated in FIG. 1.

Once that the laser photon is incident on the specimen, the photon energy of the laser is transferred to an electron during the time between several femtoseconds (fs) and several picoseconds (ps) due to inverse bremsstrahlung and also carrier-carrier scattering occurs between the electrons. After that, carrier-phonon scattering occurs between the electron and the lattice of the material during several ps. After a few nanoseconds (ns), pressure or shock wave spreads from the focal point and the heat begins to spread to the neighboring region. As a result, when the laser having the pulse width under several ps responds to the material, the energy transfer from the laser to the specimen is completed before elapse of several ps, that is, before the energy begins to spread between the electron and the lattice, and thus the photon energy is just supplied and is not spread to be trapped at the focal point of the laser. As such, nonlinear absorption due to the high peak output may be increased by focusing the ultrafast pulse laser to the inside of the transparent specimen intensively and the high temperature and the temperature gradient, which are impossible in case of the CW laser and the long pulse, may be realized because the energy spread can be blocked within several ps of providing the energy. Such temperature gradient may be used as a source of the strong tensile stress.

The conventional methods of cutting a substrate using the ultrafast pulse laser are disclosed in Korean Patent Publication No. 10-2011-0139007 published on Dec. 28, 2011, which discloses a substrate dicing Method by nano void array formation using femtosecond pulse lasers, and Korean Patent Publication No. 10-2012-0073249 published on Jul. 4, 2012, which discloses methods for laser cutting articles from chemically strengthened glass substrates.

In case of the conventional methods, however, it may be improper for processing other than straight line cutting, the additional process of applying a physical force may be required, and/or several laser illumination may be required because the crack passing through from the upper surface to the bottom surface may not be generated by the one-time illumination of the laser. Also the focus of illumination must pass through an edge of the transparent specimen so as to form a seed crack.

Importance of dicing technique of the transparent specimen is increasing in the field of the display device and technical development is required steadily such that the cut line of the curved loop and the cut surface are clear and clean, the heat affected zone is narrow so as not to affect the function of the specimen, the process of the straight line, the curved line and the arbitrary pattern is easy, there are less fragment, chip, debris, etc. and manufacturing time and cost can be reduced by decreasing the processing step number of cutting, washing etc. Particularly in case of a strengthened glass that is processed chemically, a new technique has to be developed to perform the straight line process and the curved line process conveniently.

### SUMMARY

Some example embodiments of the inventive concept provide a method of processing a transparent specimen and a dicing device for performing the method such that the cut surface of the brittle transparent specimen is clean and the desired closed surface does not include a heat affected zone that may be caused due to the laser illumination by positioning the heat affected zone in the one side region with respect to the cut line.

Some example embodiments of the inventive concept provide a method of processing a transparent specimen and a dicing device for performing the method such that processes of an arbitrary pattern including a straight line and a curved line may be possible using a femtosecond pulse laser, fragment, chip and debris may be reduced, and a crack may be generated and propagated by one-time illumination of a laser without an additional process of applying a physical force.

Some example embodiments of the inventive concept provide a method of processing a transparent specimen capable of cutting various brittle transparent specimens including a surface-strengthened specimen in addition to a typical brittle specimen.

According to example embodiments, a method of processing a transparent specimen, includes, forming a focal point by generating and focusing an ultrafast pulse laser beam from a laser source, the pulse laser beam having a pulse width of 10 femtoseconds through 10 picoseconds and a central wavelength of the pulse laser beam corresponding to a transmission band of the transparent specimen; transferring energy to an inside of the transparent specimen using the focused pulse laser beam by positioning the focal point of the pulse laser beam between an upper surface and a bottom surface of the transparent specimen; and generating and propagating a crack by relatively moving the focal point or the transparent specimen along a cut line of a desired shape such that the crack includes a portion that is propagated on the transparent specimen at a distance from a movement line of the focal point.

According to example embodiments, a method of processing a transparent specimen, includes, forming a focal point by focusing a pulse laser beam in an inside region between an upper surface and a bottom surface of the transparent specimen, a central wavelength of the pulse laser beam corresponding to a transmission band of the transparent specimen, the pulse laser beam having a pulse width of 10 femtoseconds through 10 picoseconds at a final output terminal; moving the focal point along a cut line of a desired shape; and generating and propagating a crack along a line connecting points corresponding to peak maximum stresses due to temperature gradient around the focal point in the transparent specimen.

In an example embodiment, the crack may be propagated along the movement line of the focal point with including a process at least one time such that the crack is propagated apart from the movement line to one side direction of the transparent specimen, the crack passes through the movement line of the focal point and then the crack is propagated apart from the movement line to another side direction of the transparent specimen.

In an example embodiment, the crack may be propagated along the movement line of the focal point with including a process such that the crack is propagated apart from the movement line to one side direction of the transparent specimen and without including a process such that the crack is propagated apart from the movement line to another side direction of the transparent specimen.

In an example embodiment, the transparent specimen may be one selected from a glass substrate, a silicon substrate, a surface-strengthened glass substrate, a sapphire substrate, an SiC substrate, a GaN substrate, a ceramic substrate, a transparent substrate for an organic light-emitting diode (OLED) and a transparent polymer substrate for a flexible display.

In an example embodiment, a propagating direction of the crack or the distance of the crack from the movement line of the focal point may be adjusted when the crack is propagated by performing a cooling process, a heating process or a combination of the cooling process and the heating process in a neighboring region of the focal point to one side direction from the movement line of the focal point or in a neighboring region of the focal point to another side direction from the movement line of the focal point to control a temperature distribution around the focal point.

In an example embodiment, a propagating direction of the crack or the distance of the crack from the movement line of the focal point may be adjusted when the crack is propagated by adjusting at least one of a relative velocity between the focal point and the transparent specimen, a depth of the focal point into the transparent specimen, a peak output of the pulse laser beam, an average output of the pulse laser beam, a repetition rate of the pulse laser beam and an incident angle of the pulse laser beam with respect to the transparent specimen.

In an example embodiment, a cut cross section of the processed transparent specimen by the crack propagation may form a mirror surface.

In an example embodiment, the crack may be propagated in a form of a straight line, a curved line or a combination of the straight line and the curved line.

In an example embodiment, the crack may be propagated forming a closed loop and a propagation line of the crack is surrounded by the movement line of the focal point to position the propagation line of the crack within the movement line of the focal point.

In an example embodiment, the crack may begin to be formed from inside the transparent specimen by beginning a movement of the focal point not from an edge of the transparent specimen but from inside the transparent specimen.

In an example embodiment, the transparent specimen may be a strengthened glass substrate and the pulse laser beam focused inside the strengthened glass substrate has a peak power density higher than 1011 W/cm2.

In an example embodiment, an average output of the pulse laser beam may be between 0.1 W and 1 kW and a repetition rate of the pulse laser beam is between 0.1 MHz and 250 MHz.

In an example embodiment, a velocity of the focal point or the transparent specimen may be between 0.1 mm/sec and 1000 mm/sec.

In an example embodiment, processing of the transparent specimen may be completed by moving the pulse laser beam one time along the movement line of the focal point such that the transparent specimen is cut out or a portion of the transparent specimen is separated from another portion of the transparent specimen.

According to example embodiments, a method of processing a transparent specimen, includes, forming a focal point by generating and focusing an ultrafast pulse laser beam from a laser source, the pulse laser beam having a pulse width of 10 femtoseconds through 10 picoseconds and a central wavelength of the pulse laser beam corresponding to a transmission band of the transparent specimen; transferring energy to an inside of the transparent specimen using the focused pulse laser beam by positioning the focal point of the pulse laser beam between an upper surface and a bottom surface of the transparent specimen; and generating and propagating a crack by relatively moving the focal point or the transparent specimen along a cut line of a desired shape such that the crack includes a portion that is propagated on the transparent specimen maintaining a positive offset distance from a movement line of the focal point to a first side direction of the transparent specimen or maintaining a negative offset distance from the movement line of the focal point to a second side direction of the transparent specimen.

According to example embodiments, a dicing device of processing a transparent specimen, includes, a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen, a focusing system including at least one mirror and at least one lens configured to focus the pulse laser beam from the laser source, a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen, a crack-direction control unit configured to adjust a propagation direction of the crack by controlling a temperature distribution in a neighboring region of a focal point to one side direction from a movement line of the focal point or in a neighboring region of the focal point to another side direction from the movement line of the focal point; and a controller configured to control the laser source, the focusing system, the three-dimensional moving stage system and the crack-direction control unit, where the crack includes a portion that is generated and propagated on the transparent specimen at a distance from the movement line of the focal point.

In an example embodiment, the crack-direction control unit may be configured to adjust a propagating direction of the crack or the distance of the crack from the movement line of the focal point when the crack is propagated by performing a cooling process, a heating process or a combination of the cooling process and the heating process in the neighboring region of the focal point to the one side direction from the movement line of the focal point or in the neighboring region of the focal point to the another side direction from the movement line of the focal point to control the temperature distribution around the focal point.

In an example embodiment, the laser source may be an ultrafast laser system that further includes a pulse stretcher configured to provide a pulse in the laser resonator, a pulse amplifier configured to amplify the stretched pulse, a pulse compressor configured to compress the amplified pulse and a pulse controller configured to control characteristics of the compressed pulse.

In an example embodiment, when the transparent specimen includes a material of a compressed-strengthened glass, the pulse laser beam may have a peak power density higher than 1011 W/cm2.

In an example embodiment, an average output of the pulse laser beam may be between 0.1 W and 1 kW and a repetition rate of the pulse laser beam is implemented between 0.1 MHz and 250 MHz using the laser resonator based on an optical fiber.

In an example embodiment, the focused pulse laser beam may be moved in the X-direction, the Y-direction and the Z-direction instead of moving the transparent specimen.

In an example embodiment, the dicing device may further include an auto-focusing system configured to position the focal point of the focused pulse laser beam at a desired location inside the transparent specimen between an upper surface and a bottom surface of the transparent specimen to control the focal point in real time.

In an example embodiment, the crack-direction control unit may be configured to control the temperature distribution around the focal point such that the crack-direction control unit cools or heats a portion of the transparent specimen (i) by heating, spraying a cooled gas to or providing a radiant heat to the neighboring region of the focal point to the one side direction or to the neighboring region of the focal point to the another side direction, (ii) by contacting a heated or cooled plate to the neighboring region of the focal point to the one side direction or to the neighboring region of the focal point to the another side direction and (iii) by including an additional laser for providing thermal energy.

According to example embodiments, a dicing device of processing a transparent specimen, includes, a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen; a focusing system including at least one mirror and at least one lens configured to focus the pulse laser beam from the laser source; a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen; a crack-direction control unit configured to adjust a propagation direction of the crack by controlling a temperature distribution in a neighboring region of a focal point to one side direction from a movement line of the focal point or in a neighboring region of the focal point to another side direction from the movement line of the focal point; and a controller configured to control the laser source, the focusing system, the three-dimensional moving stage system and the crack-direction control unit, where the crack includes a portion that is generated and propagated on the transparent specimen along a line connecting points corresponding to peak maximum stresses due to temperature gradient around the focal point in the transparent specimen.

According to example embodiments, a dicing device of processing a transparent specimen, includes, a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen; a focusing system including at least one mirror and at least one lens configured to focus the pulse laser beam from the laser source; a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen; and a controller configured to control the laser source, the focusing system and the three-dimensional moving stage system, where the crack includes a portion that is generated and propagated on the transparent specimen at a distance from a movement line of a focal point.

According to example embodiments, a dicing device of processing a transparent specimen, includes, a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen; a focusing system including at least one mirror and at least one lens configured to focus the pulse laser beam from the laser source; a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen; and a controller configured to control the laser source, the focusing system, the three-dimensional moving stage system and the crack-direction control unit, where the crack includes a portion that is generated and propagated on the transparent specimen along a line connecting points corresponding to peak maximum stresses due to temperature gradient around a focal point in the transparent specimen.

The example embodiments of the inventive concept may provide the method of processing the transparent specimen and the dicing device for implementing the method such that the cut surface of the brittle transparent specimen is clean and the desired closed surface does not include the heat affected zone by positioning the heat affected zone selectively in the one side region with respect to the cut line.

In addition, the example embodiments of the inventive concept may provide the method of processing the transparent specimen and the dicing device for implementing the method such that processes of an arbitrary pattern including a straight line and a curved line may be possible using a femtosecond pulse laser, fragment, chip and debris may be reduced, and a crack may be generated and propagated by one-time illumination of a laser without an additional process of applying a physical force.

Furthermore, the example embodiments of the inventive concept may provide the method of processing the transparent specimen capable of cutting various brittle transparent specimens including a surface-strengthened specimen in addition to a typical brittle specimen.

### BRIEF DESCRIPTION OF THE DRAWINGS

Example embodiments of the inventive concept will be more clearly understood from the following detailed description taken in conjunction with the accompanying drawings.

FIG. 1 is a diagram illustrating physical phenomena between an ultrafast pulse laser and a transparent specimen according to time scale.

FIG. 2 is a diagram illustrating temperature variation over time at a focal point when an ultrafast pulse laser having a pulse width of about 200 fs is illuminated in a transparent specimen through an object lens.

FIG. 3 is a diagram illustrating temperature variation over time at a focal point when a pulse laser having a pulse width over about 10 ps is illuminated in a transparent specimen through an object lens.

FIG. 4 is a diagram illustrating temperature distribution, resulting temperature gradient and residual tensile stress distribution along a cross-sectional line of R-R′ when an ultrafast pulse laser is illuminated to a point in a transparent specimen through an object lens.

FIG. 5 is a diagram illustrating a crack propagation during a relative motion between an ultrafast pulse laser and a transparent specimen, and temperature distribution, resulting temperature gradient and residual tensile stress distribution along a cross-sectional line of R-R′.

FIG. 6 is a diagram illustrating two examples of cutting result when a strengthened glass having a width of 0.7 mm, a strengthened width of 0.02 mm and a surface strength of 700 MPa (megapascal) is cut while a slight left-right asymmetry exists.

FIG. 7 is a diagram illustrating an example of cutting result when the strengthened glass of FIG. 6 is cut while a great left-right asymmetry exists.

FIG. 8 is a diagram illustrating an example of cutting result when the strengthened glass of FIG. 6 is cut while a left-right symmetry exists.

FIG. 9 is a diagram illustrating an example of cutting result when the strengthened glass of FIG. 6 is cut in a pattern of a curved line.

FIG. 10 is a conceptual diagram illustrating characteristics of crack propagation when a laser is incident on a specimen normally and obliquely.

FIGS. 11A, 11B and 11C are diagrams illustrating examples of cutting result when the strengthened glass of FIG. 6 is cut by applying an oblique incidence.

FIG. 12 is a diagram for describing that magnitude of a residual tensile stress is varied at two positions by controlling temperature distribution around a illumination position of a laser.

FIG. 13 is a diagram illustrating an example of cutting result when the strengthened glass of FIG. 6 is cut with control of characteristics of crack propagation by controlling temperature distribution in a bottom plate.

FIG. 14 is a diagram illustrating photographs of performing a curved line process when the strengthened glass of FIG. 6 is cut in a form of a closed loop including a straight line and a curved line with controlling temperature distribution around a laser illumination line.

FIG. 15 is a diagram illustrating examples of cutting result when the strengthened glass of FIG. 6 is cut using lasers of various pulse widths.

FIG. 16 is a diagram illustrating enlarged photographs of cutting result when the strengthened glass of FIG. 6 is cut using lasers of various pulse widths.

FIG. 17 is a diagram illustrating enlarged photographs of cutting result when the strengthened glass of FIG. 6 is cut using lasers of various pulse widths.

FIG. 18 is a diagram illustrating a cut surface that is obtained when a silicon wafer is cut using a stealth dicing method of Hamamatsu Company.

FIG. 19 is a diagram illustrating a cut surface that is obtained when the strengthened glass of FIG. 6 is cut using a method of processing a transparent specimen according to an example embodiment.

FIGS. 20A and 20B are diagrams illustrating cut positions and limiting conditions with respect to various combinations of an average power, a stage speed and a repetition rate.

FIG. 21 is a diagram illustrating a cutting result of a gorilla 2 glass specimen using a method of processing a transparent specimen according to an example embodiment.

FIG. 22 is a diagram illustrating a crack that is generated when a pulse entrance point and a pulse exit point are positioned inside a transparent specimen.

FIG. 23 is a block diagram illustrating a dicing device of processing a transparent specimen according to example embodiments.

FIGS. 24A, 24B and 24C are diagrams for describing an example embodiment of a crack-direction control unit for cooling or heating left and right side portions with respect to a movement line of a focal point.

FIGS. 25A, 25B and 25C are diagrams for describing an example embodiment of a crack-direction control unit including a heat bottom plate for forming temperature gradient by differently controlling temperature of left and right side portions with respect to a movement line of a focal point.

### DETAILED DESCRIPTION OF THE EMBODIMENTS

Various example embodiments will be described more fully hereinafter with reference to the accompanying drawings, in which some example embodiments are shown. In the accompanying drawings, size or dimension of structures may be enlarged or reduced for clearness of the inventive concept and the well-known structures may be omitted to give prominence to features related with the inventive concept. In describing principles of example embodiments, the detailed description of the well-known function and configuration may be omitted if such description may bur the inventive concept.

In this disclosure, a processing method of a transparent specimen represents a method of separating a portion of the transparent specimen from another portion of the transparent specimen, which is caused by generating a crack through upper and bottom surfaces along a stress line formed in the transparent specimen. Accordingly the processing method corresponds to a cutting method if the processing of the transparent specimen includes both end edges, and corresponds to a partially cutting method if both ends of a cut line are included in the transparent specimen or the cut line is from an edge of the transparent specimen to a position inside the transparent specimen. In addition, the processing method may include a cutting out a portion of the transparent specimen so that the other portion of the transparent specimen is separated from the cutout portion when the cut line has a shape of a closed loop.

In this disclosure, an offset distance or an offset interval represents a distance of a point on a line from a reference line including a straight line, a curved line or a combination of straight and curved lines. A positive offset distance may represent the offset distance to one side direction and a negative offset distance may represent the offset distance to the other side direction when the transparent specimen is divided in two spatial areas based on the reference line.

The present invention uses an ultrafast pulse laser having a central wavelength corresponding to a transmission band of a brittle transparent specimen and focuses sufficient energy at a focal point inside the transparent specimen using a focusing lens and the ultrafast pulse laser having a pulse width of several femtoseconds (fs) through several picoseconds (ps). The pulse energy transfer may be completed before the energy is transferred and spread to the neighboring region to form a high temperature at the focusing position, a temperature gradient and a distribution of residual tensile stress around the focusing position. Thus the sufficient tensile stress may be obtained to form a crack passing through from a upper surface to a bottom surface of the transparent specimen. The transparent specimen may be cut in a desired pattern and also the entire cur cross section may form a mirror surface by moving the laser and the specimen relatively to propagate the crack such that the line of the maximum residual tensile stress is apart at a distance from a movement line of the focal point. Hereinafter, the example embodiments are described in detail.

The present invention provides a method of processing a transparent specimen, including, forming a focal point by generating and focusing an ultrafast pulse laser beam from a laser source where the pulse laser beam has a pulse width of 10 femtoseconds through 10 picoseconds and a central wavelength of the pulse laser beam corresponding to a transmission band of the transparent specimen, transferring energy to an inside of the transparent specimen using the focused pulse laser beam by positioning the focal point of the pulse laser beam between an upper surface and a bottom surface of the transparent specimen, and generating and propagating a crack by relatively moving the focal point or the transparent specimen along a cut line of a desired shape such that the crack includes a portion that is propagated on the transparent specimen at a distance from a movement line of the focal point.

The laser used in generating the pulse laser beam and forming the focal point has the central wavelength corresponding to the transmission band of the transparent specimen so as to form the focal point inside the transparent specimen. In an example embodiment, the output wavelength of the laser may be in the range of 300 nm through 3000 nm, which corresponds to the transmission band of the specimens widely used in the industrial field.

In example embodiments, the transparent specimen may be one selected from a glass substrate, a silicon substrate, a surface-strengthened glass substrate, a sapphire substrate, an SiC substrate, a GaN substrate, a ceramic substrate, a transparent substrate for an organic light-emitting diode (OLED) and a transparent polymer substrate for a flexible display. Particularly the glass substrate, the silicon substrate, the surface-strengthened glass substrate, or the sapphire substrate may be used as the transparent specimen.

The surface-strengthened glass substrate has a surface compressed region and a bulk tensile region which are strengthened chemically and the crack may be formed easily since the laser beam moves in the bulk tensile region.

The laser for processing of the transparent specimen is the ultrafast pulse laser having the pulse width of 10 femtoseconds through 10 picoseconds so as to cause sufficient nonlinear absorption in the transparent specimen to be processed. If the pulse width is broader than 10 picoseconds, the formed temperature and the temperature gradient are relatively low in comparison with the ultrafast pulse laser used in example embodiments. The economic cost and the technical difficulty are increased to implement the pulse width narrower than 10 femtoseconds.

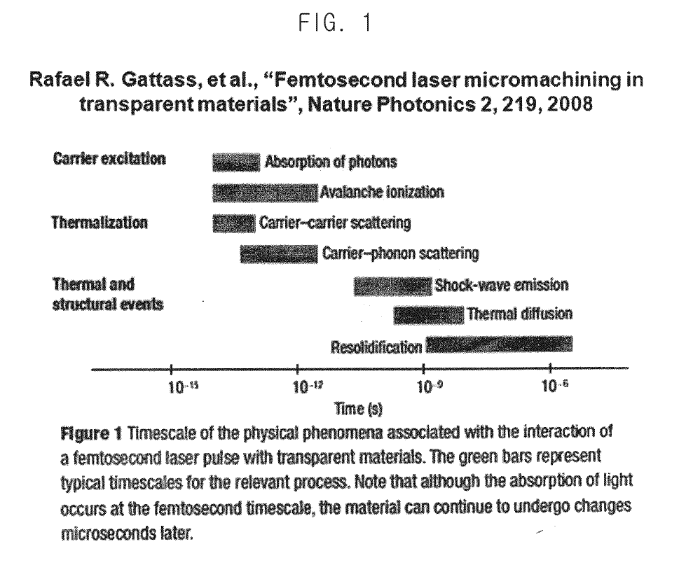

As mentioned above, the physical phenomena occurring when the ultrafast pulse laser and the transparent specimen react with each other may be represented as illustrated in FIG. 1.

If the laser corresponding to the penetrating wavelength of the specimen is incident on the specimen, the photon energy of the laser is transferred to an electron in the specimen through inverse bremsstrahlung. The brittle specimen of the glass-class has the very low electron density and thus multi-photon ionization occurs mainly during the initial stage such that several photons excite one bound electron (about several ten through several hundred femtoseconds). The free electrons that have been freed by absorbing the photon energy transfer the energy to other bound electrons (Carrier-carrier scattering) to generate additional free electrons (Avalanche ionization) and the raised density of the free electrons causes the laser absorption rate of the specimen to increase. The timescale for the phenomena continues for several picoseconds after the photon is incident. There happen collisions between electrons and lattices (Carrier-phonon scattering) simultaneously with photon absorption by the electrons, and the temperature of the specimen increases by the carrier-phonon scattering. Such heat transfer continues for several picoseconds. As a result, when the laser having the pulse width under several ps responds to the material, the energy transfer from the laser to the specimen is completed before the energy spreads to the neighboring region, and thus the high temperature and temperature gradient may be implemented through the thermal accumulation.

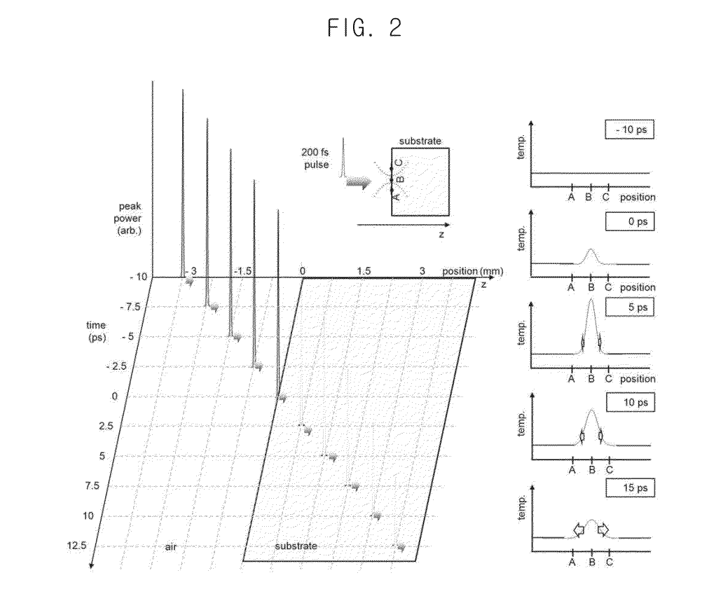

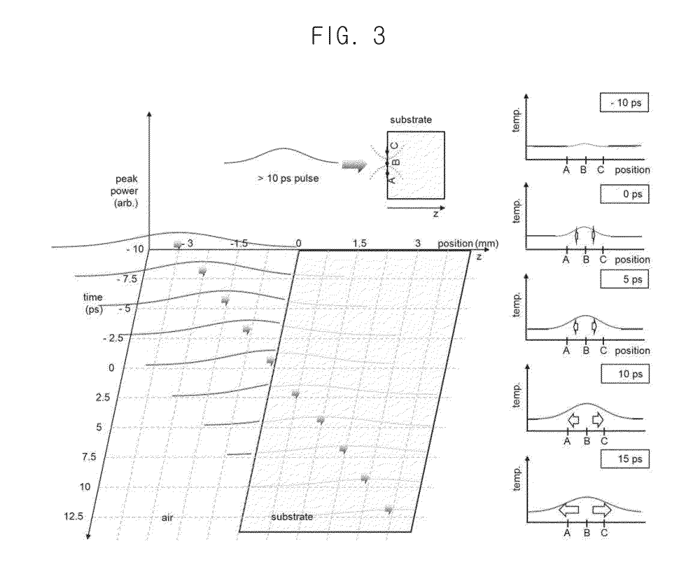

The above descriptions may be further understood by referring to FIGS. 2 and 3. FIG. 2 illustrates temperature variation over time at a focal point when an ultrafast pulse laser having a pulse width of about 200 fs is illuminated in a transparent specimen through an object lens. As mentioned above, the locally high temperature and the temperature gradient centered on it may be formed due to the pulse width shorter than the time (about several picoseconds) for the heat diffusion.

FIG. 3 illustrates temperature variation over time at a focal point when a pulse laser having a pulse width over about 10 ps is illuminated in a transparent specimen through an object lens. The energy transfer by the laser pulse and the heat diffusion happen at the same time due to the pulse width longer than the time (about several picoseconds) for the heat diffusion, and thus the temperature and temperature gradient are low in comparison with the ultrafast pulse laser.

As such, the transparent specimen may be processed according to example embodiments, by causing the locally high temperature and abrupt temperature gradient centered on it using the ultrafast pulse laser having the pulse width of 10 femtosecond through 10 picoseconds that is shorter than the time for the heat diffusion from the focal point in the specimen.

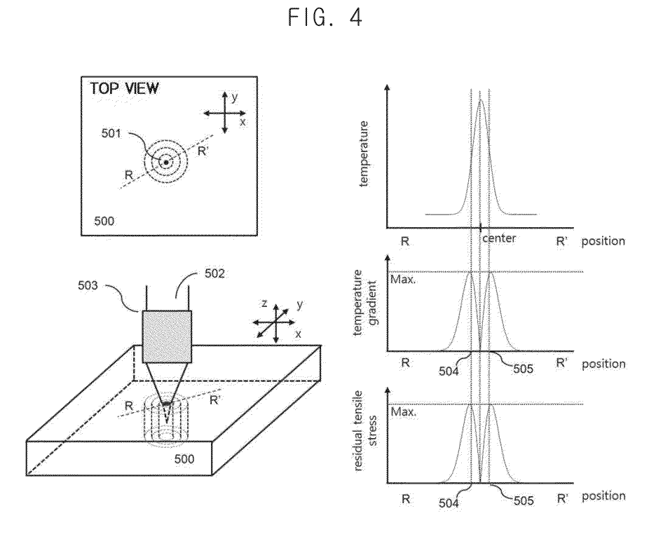

According to example embodiments, transferring energy to the transparent specimen by the pulse laser beam may be implemented by positioning the focal point or the beam waist of the pulse laser beam between an upper surface and a bottom surface of the transparent specimen as illustrated in FIG. 4.

FIG. 4 illustrates temperature distribution, resulting temperature gradient and residual tensile stress distribution along a cross-sectional line of R-R′ around the focal point 501 when the ultrafast pulse laser 502 is illuminated to a point inside the transparent specimen 500 through an object lens 503.

When the laser is focused at the focal point 501 to form the temperature gradient of the radial form, also the distribution of the residual tensile stress, which is based on the temperature gradient, has the radial form. The object lens 503 may be adjusted from 5 magnification to 100 magnification depending on the required peak output and various characteristics of the specimen 500 and the diameter of the focal point may be from several μm to several ten μm. Such diameter of the focal point 501 shows the similar scale to the offset distance between a laser illumination line and a crack line as will be described below.

As illustrated in FIG. 4, the temperature of the transparent specimen has a maximum value at the focal point but the temperature gradient has local maximum values at the positions 504 and 505 apart at a distance from the focal point. Also the residual tensile stress has local maximum values at the positions 504 and 505 apart at the distance from the focal point.

According to example embodiments, generating and propagating the crack, such that the crack includes a portion that is propagated on the transparent specimen at a distance from a movement line of the focal point, may be implemented by relatively moving the focal point or the transparent specimen along a cut line of a desired shape. For example, the relative moving may be implemented by mounting the specimen on a three-dimensional moving stage and by moving the stage in an X-direction, a Y-direction and a Z-direction. In contrast, the transparent specimen may be mounted on the fixed stage or plate and then the laser beam may be moved in the X-direction, the Y-direction and the Z-direction to relatively move the focal point.

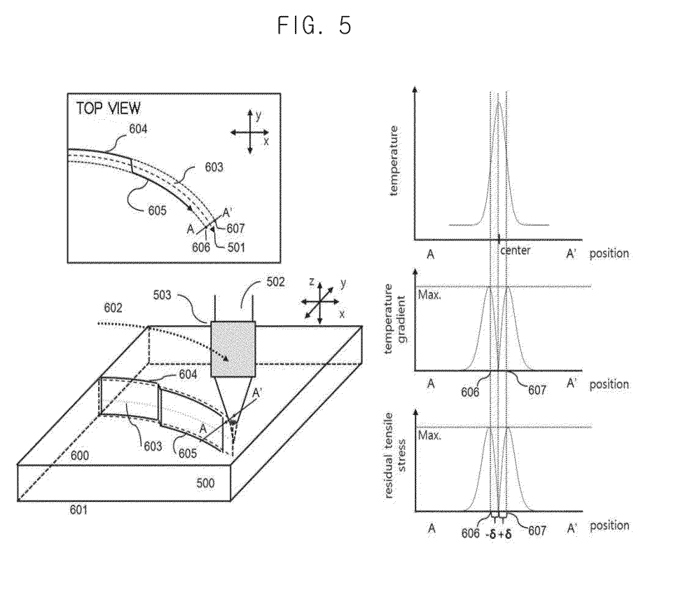

FIG. 5 is a diagram illustrating a crack propagation during a relative motion between an ultrafast pulse laser and a transparent specimen, and temperature distribution, resulting temperature gradient and residual tensile stress distribution along a cross-sectional line of R-R′. The generation and propagation of the crack of the present invention may be described with reference to FIG. 5.

The ultrafast pulse laser 502 is focused inside the transparent specimen 500 between both surfaces 600 and 601 and the focal point is moved along the relative motion path 502. The strong stress distribution is formed in the transparent specimen through the heat by the focused laser and the crack is formed in the vertical direction passing through the upper surface and the bottom surface and the crack is propagated along the crack lines 604 and 605.

The heat affected zone may be observed by the high peak output of the laser around the movement line 603 of the laser focal point in the transparent specimen. The heat affected zone may result in change of characteristics of the specimen and development of undesired cracks. According to example embodiments, the heat affected zone may be positioned selectively through temperature control of particular portions of the specimen. For example, when the transparent specimen is processed in a form of a closed loop, the heat affected zone may be positioned outside the closed loop that is formed by the crack propagation, and thus the finally obtained portion of the transparent specimen may not include the heat affected zone, which is further described below.

According to example embodiments, the crack may be propagated along the movement line of the focal point with including a process at least one time such that the crack is propagated on the transparent specimen maintaining a positive offset distance from the movement line of the focal point to one side direction of the transparent specimen, passing through the movement line of the focal point and then maintaining a negative offset distance from the movement line of the focal point to the other side direction of the transparent specimen.

Compared with the conventional techniques where the crack is propagated such that the crack line is on the movement line of the laser focal point, the crack is propagated according to example embodiments such that the crack lines 604 and 605 are apart from the movement line 603 of the laser focal point maintaining the offset distance from the movement line 603 of the focal point. Sometimes the crack may pass through the movement line 603 of the focal point to maintain the offset distance to the opposite direction.

Referring to FIG. 5, the crack may be propagated along the movement line 603 of the focal point with including a process at least one time such that the crack is propagated along the line 604 apart from the movement line 603 of the focal point to one side direction 607 maintaining the offset distance, and the crack passes through the movement line 603 to be propagated along the line 605 apart from the movement line 603 of the focal point to the other side direction 606 maintaining the offset distance. The crack may be controlled to pass through the focal line by changing the temperature condition to the one side direction 607 or to the other side direction 606 with respect to the movement line 603 of the focal line. The one side direction 607 may be a direction to the crack line 604 from the movement line 603 of the focal point and the other side direction 606 may be a direction to the crack line 605 from the movement line 603 of the focal point.

The crack line may pass through the movement line of the focal point as results of forming the high temperature gradient by the ultrafast pulse laser and the small focusing diameter of several μm to several ten μm using the focusing lens according to example embodiments.

As described with reference to FIG. 4, when the ultrafast pulse laser is focused in the transparent specimen, the temperature of the transparent specimen has the maximum value at the focal point, but the maximum temperature gradient and the maximum residual tensile stress have the radial form and thus the crack lines 604 and 605 are in parallel with the movement line 603 of the focal point with the offset distance 8. The parallel crack lines 604 and 605 may be obtained because the initial seed crack, which is formed by the initial reaction between the laser and the specimen, propagates along the line of the maximum residual tensile stress. The illumination line of the laser functions as the barrier line to the crack and thus the parallel crack lines may be obtained unless the external conditions are changed.

As such, according to example embodiments, the crack includes a portion that is generated and propagated on the transparent specimen along a line connecting points corresponding to peak maximum stresses due to temperature gradient around the focal point in the transparent specimen. The crack lines may maintain the offset distance from the movement line of the focal point.

The offset distance between the propagation line of the crack and the movement line of the focal point may be changed by the average output, the repetition rate and the pulse width of the laser and the magnification of the focusing lens. For example, the offset distance may be from 1 μm to several mm, and more particularly from 10 μm to 200 μm.

The crack lines 604 and 605 may pass through the movement line 603 of the focal point because the interval 26 between the positions 606 and 607 of the maximum residual tensile stress is sufficiently small between several ten μm and several hundred μm due to the small focusing diameter of several μm.

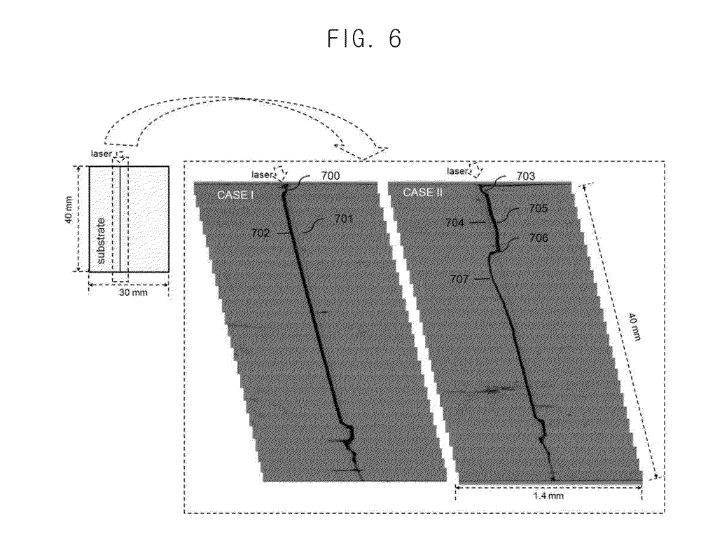

FIG. 6 is a diagram illustrating two examples of cutting result when a strengthened glass (IOX-FX specimen, Soda-lime glass) having a size of 30*40*0.7 mm, a strengthened width of 0.02 mm and a surface strength of 700 MPa is cut using the ultrafast pulse laser having a central wavelength of 1 μm, a repetition rate of 5 MHz, an average output of 2.5 W and a pulse width of 200 femtoseconds. The photographs are obtained using a microscope to clarify the crack line and the laser illumination line. The laser incident start position is about 12 mm from the left side of the specimen to the center, that is, about 3 mm to the left side direction from the center, and the laser illumination line is parallel with the side lines of the specimen. The photographs are seen to be inclined for convenience of illustration. A slight asymmetry exists in the left and right portions of the specimen with respect to the laser illumination line 701. The asymmetry causes a difference of the diffusion velocity between the left and right side directions and the temperature in the region of the slower diffusion velocity is formed relatively higher to induce a difference of stress values between the residual tensile stress lines. Such difference of the stress values relieves the tendency of the crack to pass through the laser illumination line 701, and thus the result of CASE I having the uniform negative offset (−δ) of about 80 μm from the laser illumination line 701.

The result of CASE II may be obtained by a certain ratio where the stress difference is small because the asymmetry of the specimen is relatively small at the crack start position. Different from the crack start position 700 of CASE I, the crack starts from the position 703 in CASE II to be propagated by selecting the residual tensile stress line 705 having the positive offset (+δ). As a result, after progressing about 1 cm, the crack passes through the barrier of the laser illumination line 704 at the portion 706 to show the large offset and then the crack is propagated along the opposite residual tensile stress line having the negative offset (−δ).

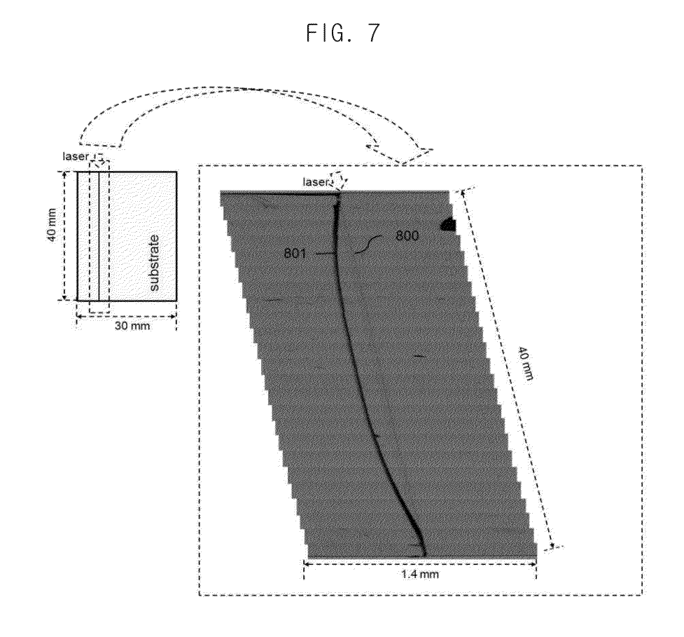

FIG. 7 is a diagram illustrating an example of cutting result when the strengthened glass of FIG. 6 is cut while a great left-right asymmetry exists. The crack start position is about 5 mm from the left side of the specimen toward the center and 10 mm from the center. The laser illumination line 800 is parallel with the side lines of the specimen. When the asymmetry between the left and right portions of the specimen is great, the offset between the crack line 801 and the laser illumination line 80 increases by inertia of crack propagation and the offset decreases to finish the cutting process. Here, the maximum offset is about 200 μm.

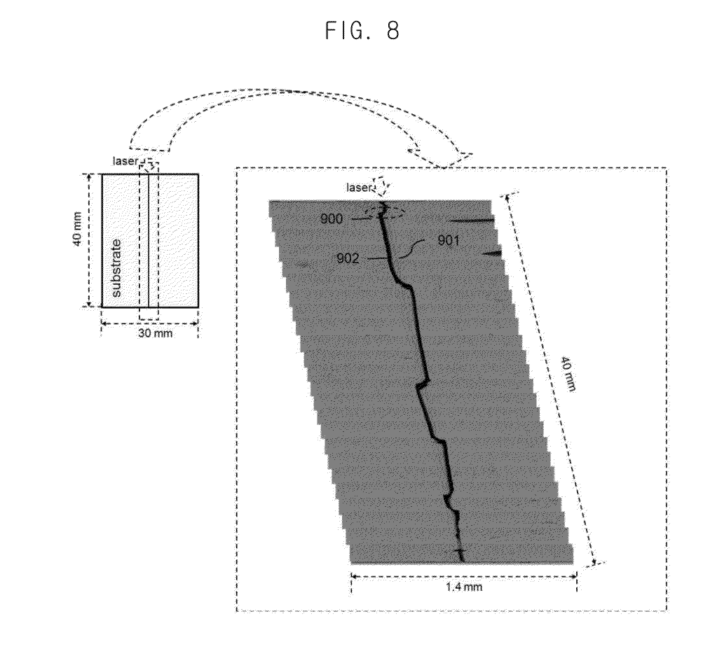

FIG. 8 is a diagram illustrating an example of cutting result when the strengthened glass of FIG. 6 is cut by illuminating the laser in the center of the specimen. In this case, the left and right portions of the specimen are symmetric with respect to the laser illumination line 901 and the difference of the tensile stress between the residual tensile stress lines due to asymmetry of the specimen is negligible. As a result, the crack may pass through the laser illumination line 901 by the stress difference between the residual tensile stress lines without additional temperature control as will be described below.

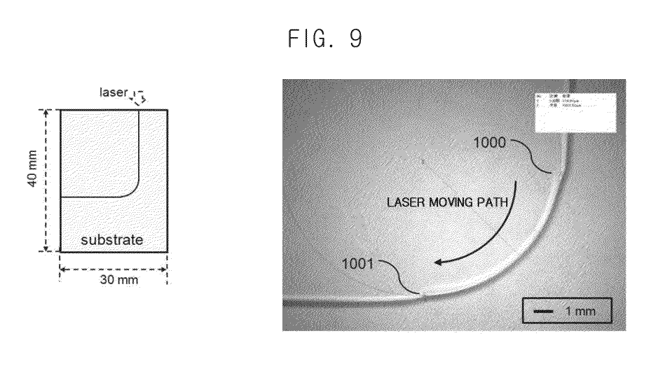

FIG. 9 is a diagram illustrating an example of cutting result when the strengthened glass of FIG. 6 is cut in a pattern of a curved line. The specimen and the laser pulse are the same as FIG. 6, and the cutting process has been performed along a straight line, a curved line and then another straight line. The crack may be propagated along the maximum residual tensile stress line of the positive offset due to the asymmetry with respect to the laser illumination line and then shifts to the maximum residual tensile stress line of the negative offset at the position 1000 where the process of the curved line begins because the crack tends to move toward the center of the rotation. After that, the crack shifts again to the maximum residual tensile stress line of the positive offset at the position 1001 where the process of the straight line begins.

According to example embodiments, a propagating direction of the crack or the distance of the crack from the movement line of the focal point may be adjusted when the crack is propagated by adjusting at least one of a relative velocity between the focal point and the transparent specimen, a depth of the focal point into the transparent specimen, a peak output of the pulse laser beam, an average output of the pulse laser beam, a repetition rate of the pulse laser beam and an incident angle of the pulse laser beam with respect to the transparent specimen.

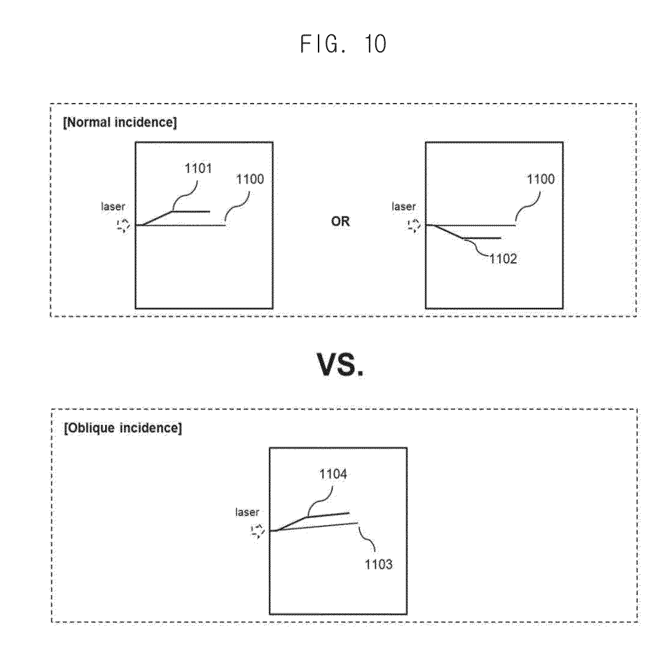

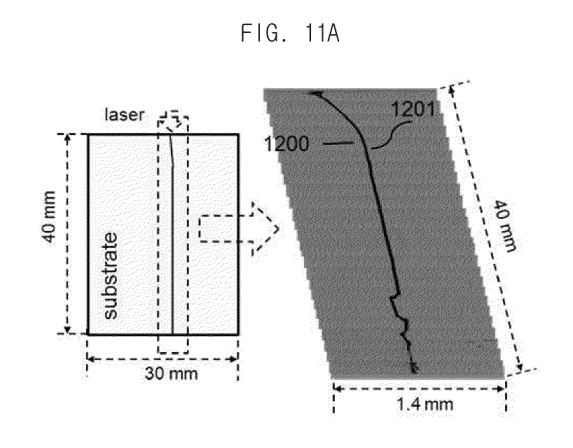

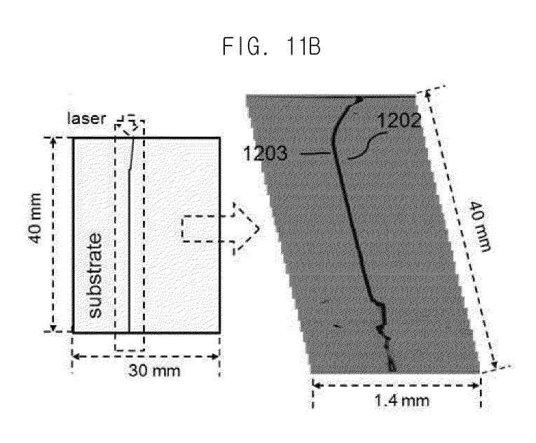

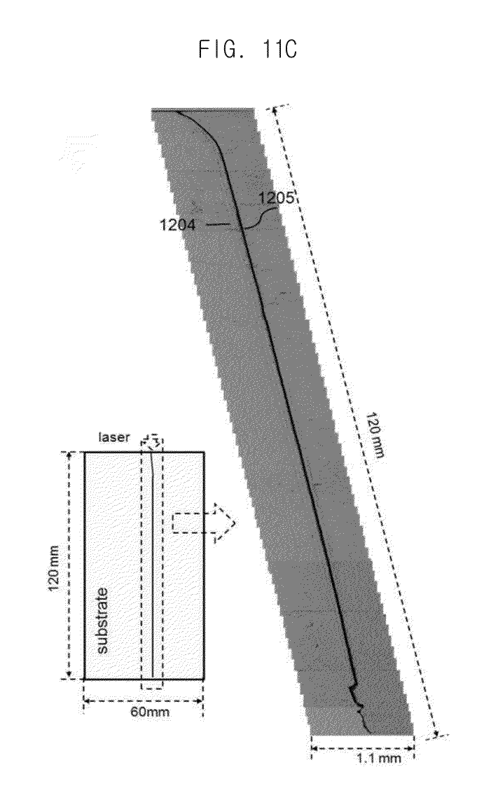

For example, the propagation characteristics of the crack may be changed depending on the incident angle of the pulse laser beam with respect to the transparent specimen, and thus the crack may be controlled by controlling the incidence angle as illustrated in FIGS. 10 and 11.

FIG. 10 is a conceptual diagram illustrating characteristics of crack propagation when a laser is incident on a specimen normally and obliquely. When the laser is incident in the specimen normally (1100) as illustrated in the upper portion of FIG. 10, the crack may be propagated by selecting one of the crack lines 1101 and 1102. If the incident angle of the laser is changed slightly 1103 as illustrated in the bottom portion of FIG. 10, local asymmetry may be caused and thus the crack is propagated by selecting the residual tensile stress line located in the narrower region among the two cutting regions.

FIGS. 11A, 11B and 11C are diagrams illustrating examples of cutting result when the strengthened glass of FIG. 6 is cut by applying an oblique incidence.

FIG. 11A illustrates the result that the crack is induced along the residual tensile stress line 1201 of the positive offset from the laser illumination line 1200 of positive-direction oblique incidence, and FIG. 11B illustrates the result that the crack is induced along the residual tensile stress line 1203 of the negative offset from the laser illumination line 1202 of negative-direction oblique incidence. FIG. 11C illustrates the similar case to FIG. 11A except the length of the specimen is extended to 12 cm. Compared with the case of FIG. 11A, the result of FIG. 11C shows that the length of the unstable portions including the initial cutting portion and the final cutting portion is substantially the same as FIG. 11A but the length of the stable intermediate portion is prolonged. Therefore the accurate cutting result may be obtained using example embodiments of the present invention even though the cutting length is long.

The oblique incidence may be applied to induce the particular direction of the crack to the desired residual tensile stress line and improve the uncertainty property such that the seed crack is propagated arbitrary one of the two residual tensile stress lines due to the local symmetry characteristics of the specimen just after the laser is incident as described with reference to FIG. 6.

As such, the propagation path of the crack may be controlled among the one side direction and the other side direction by inducing the local asymmetry between the two residual tensile stress lines using the oblique incidence according to example embodiments.

According to some example embodiments, the direction of the crack may be adjusted during the entire cutting process through control of temperature or stress around the focal point in the transparent specimen.

In other words, the propagating direction of the crack or the distance of the crack from the movement line of the focal point is adjusted when the crack is propagated by performing a cooling process, a heating process or a combination of the cooling process and the heating process in a neighboring region of the focal point to one side direction from the movement line of the focal point or in a neighboring region of the focal point to another side direction from the movement line of the focal point to control a temperature distribution around the focal point.

For example, through such control of the temperature or the stress around the focal point, the crack may be propagated along the movement line of the focal point with including a process such that the crack is propagated apart from the movement line to one side direction of the transparent specimen and without including a process such that the crack is propagated apart from the movement line to another side direction of the transparent specimen.

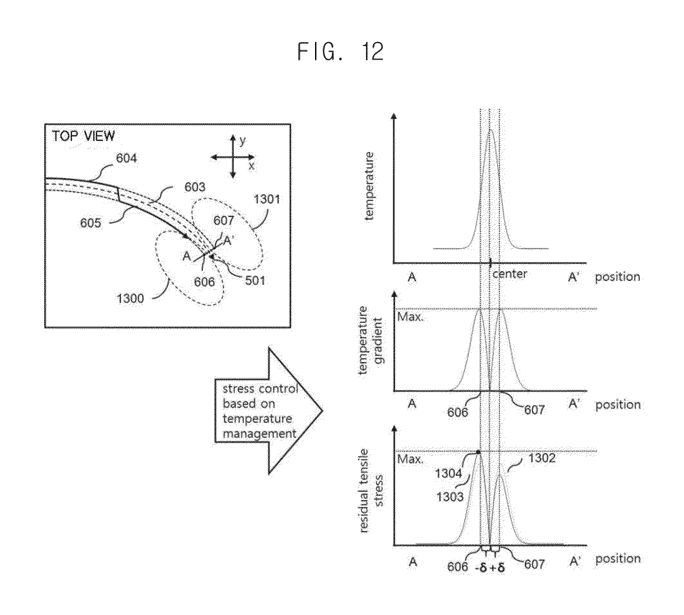

As such, at least one of the cooling process and the heating process may be performed in the neighboring region to the one side direction or the neighboring region to the other side direction from the movement line of the focal point to control the temperature distribution around the focal point, and thus the crack may be propagated to only one of both side directions or to both side directions with passing through the movement line of the focal point. Through the cooling process, the heating process and the combination of the cooling and heating processes to control the temperature distribution around the focal point, the propagating direction of the crack or the distance of the crack from the movement line of the focal point may be adjusted as illustrated in FIG. 12.

FIG. 12 is a diagram for describing that magnitude of a residual tensile stress is varied at two positions by controlling temperature distribution around an illumination position of a laser. The residual tensile stress may be changed from the original graph 1302 to the modified graph 1303 by heating or cooling at least one of the portion 1300 and 1301 in FIG. 12. As a result, the maximum tensile stress 1304 may be formed at the position 606 having the negative offset and thus the crack line may be induced finely.

Through the temperature control of the above result, the left and right regions 1300 and 1301 with respect to the laser illumination line 603 or the movement line of the focal point, the symmetry or the excessive asymmetry between the two regions 1300 and 1301 of the specimen may be overcome to suppress excessive bending of the crack and the crack's passing through the laser illumination line 603, and thus the specimen may be cut exactly along the selected one of the two maximum residual tensile stress lines. It would be understood through the above described experimental results that the crack propagation is related with the heat distribution of the specimen, and thus the exact cutting may be realized through adaptive temperature control by reversely compensation for the stress distribution due to the asymmetry of the specimen.

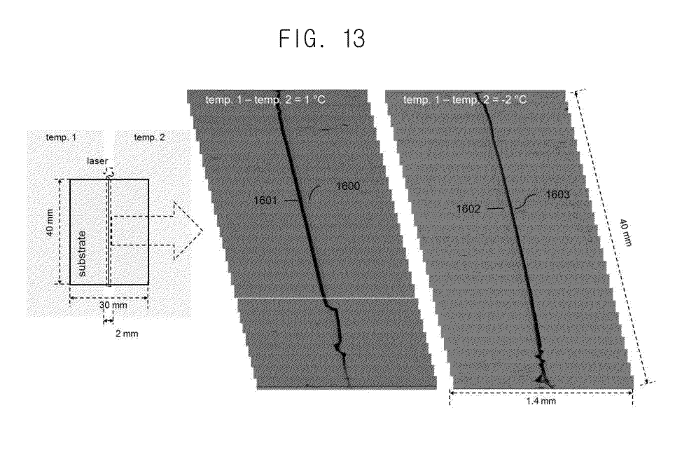

FIG. 13 is a diagram illustrating an example of cutting result when the strengthened glass of FIG. 6 is cut in case of perfect left and right symmetry with control characteristics of crack propagation by controlling temperature distribution in a bottom plate. The left photograph in FIG. 13 illustrates the case that the temperature difference is 1 degree between both portions of the transparent specimen and the right photograph in FIG. 13 illustrates the case that the temperature difference is −2 degree between both portions of the transparent specimen. The temperature difference has been generated by establishing a bottom plate, that is, a heat plate or a cooling plate beneath the transparent specimen. As illustrated in FIG. 13, it has been verified that the crack lines 1601 and 1603 are formed with the different offset signs with respect to the laser illumination lines 1600 and 1602 by the temperature change of the bottom plate even though the position of the laser incident in the specimen is fixed.

According to example embodiments, the crack may be propagated at a distance from the movement line of the focal point in a form of a straight line, a curved line or a combination of a straight line and a curved line.

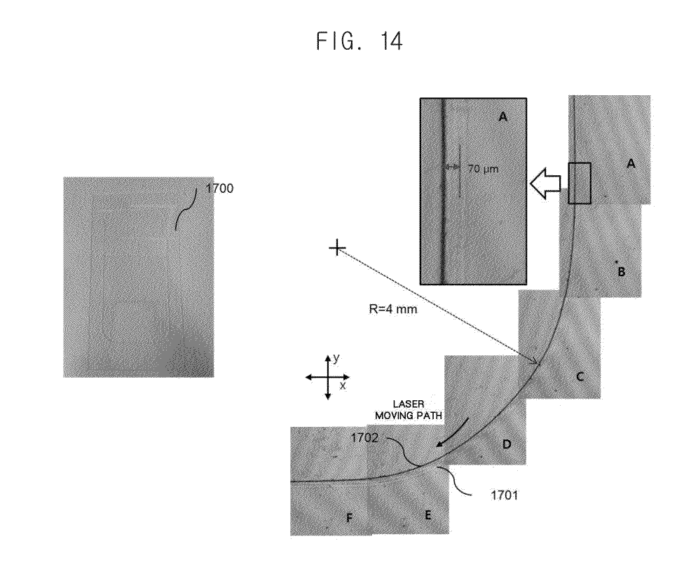

FIG. 14 is a diagram illustrating photographs of performing a curved line process when the strengthened glass of FIG. 6 is cut in a form of a closed loop including a straight line and a curved line with controlling temperature distribution around a laser illumination line. FIG. 14 illustrates a resulting photograph 1700 and enlarged photographs of several portions of the photograph 1700.

The enlarged photographs show that the crack line 1702 is formed with a positive offset value along the laser illumination line 1701 including a straight line, a curved line of a radius of 4 mm and another straight line. It has been verified that the cutting process is performed such that the propagation line 1702 is formed with the positive offset value along the barrier provided by the laser illumination line 1701.

In a method of processing a transparent specimen, the crack may be propagated forming a closed loop and the propagation line of the crack may be surrounded by the movement line of the focal point to position the propagation line of the crack within the movement line of the focal point. If the cut line of the closed loop is formed as such, the heat affected zone due to the laser illumination may be positioned selectively in one side region with respect to the cut line to exclude the heat affected zone from the other side region to be taken. As a result, the heat affected zone may not be included inside the closed loop surface and it has advantages in processing a specimen for a display device.

According to example embodiments, processing of the transparent specimen may be completed by moving the pulse laser beam one time along the movement line of the focal point such that the transparent specimen is cut out or a portion of the transparent specimen is separated from another portion of the transparent specimen. This may be an advantageous effect of the present invention capable of improving the disadvantages of the conventional method disclosed in Korean Patent Publication No. 10-2012-0073249.

A seed crack may be generated or a pre-process equivalent to the seed crack may be performed on or in the transparent specimen in advance before moving the focal point to process the transparent specimen.

The seed crack may be generated at an arbitrary position on the surface of the transparent specimen through physical contact using diamond, a knife, etc. or through a non-contact scheme using a laser beam. When the laser beam is used, the seed crack may be generated at an arbitrary position on the upper surface, on the bottom surface or inside the specimen.

Through such processes, the generation and the propagation of the crack may be performed further conveniently and the desired cutting result may be obtained easily by suppressing the tendency of the crack to develop to a certain direction. For example, when the crack is generated inside the specimen, the probability that the crack is generated inside the specimen and is propagated along the movement line of the focal point may be increased if the laser illumination begins simultaneously with varying the depth of the focal point in the Z-direction.

In addition, it has been verified that the cutting result may be improved if the laser illumination begins simultaneously with varying at least one of the pulse energy of the laser, the repetition rate of the laser and the velocity of the focal point. Once that the seed crack is generated through such processes, the following propagation of the crack becomes easier. The variations of the position in the Z-direction, the pulse energy, the velocity of the focal point and the repetition rate may be considered as the processes of generating the seed crack.

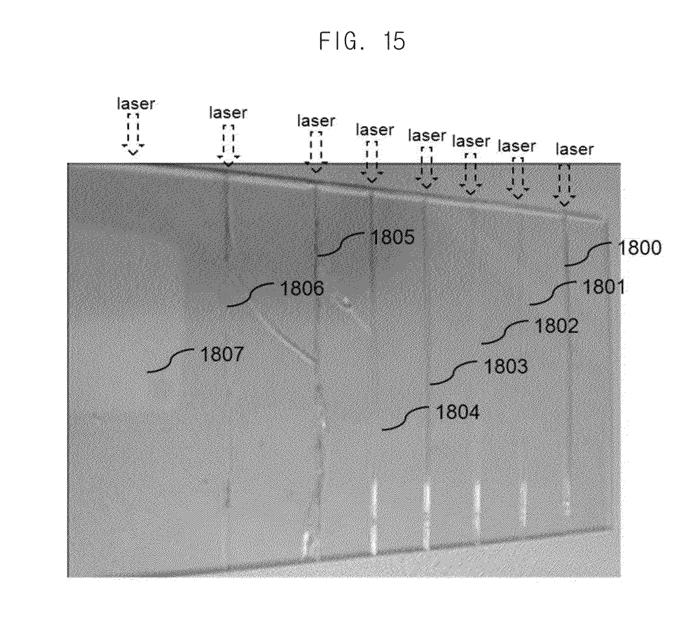

The strengthened glass of FIG. 6 has been cut using lasers of various pulse widths as illustrated in FIG. 15, so as to verify the result of processing the transparent specimen according to example embodiments.

FIG. 15 is a diagram illustrating examples of cutting result when the strengthened glass of FIG. 6 is cut using lasers of various pulse widths. More specifically, the specimen is cut with adjusting the pulse width of the laser having the central wavelength of 1 μm, the repetition of 5 MHz, the average output of 2.5 W. FIG. 15 illustrates the cutting results by the laser of the pulse widths of 200 fs (1800), 2.5 ps (1801), 5 ps (1802), 7.5 ps (1803), 10 ps (1804), 12.5 ps (1805), 15 ps (1806), 17.5 ps (1807).

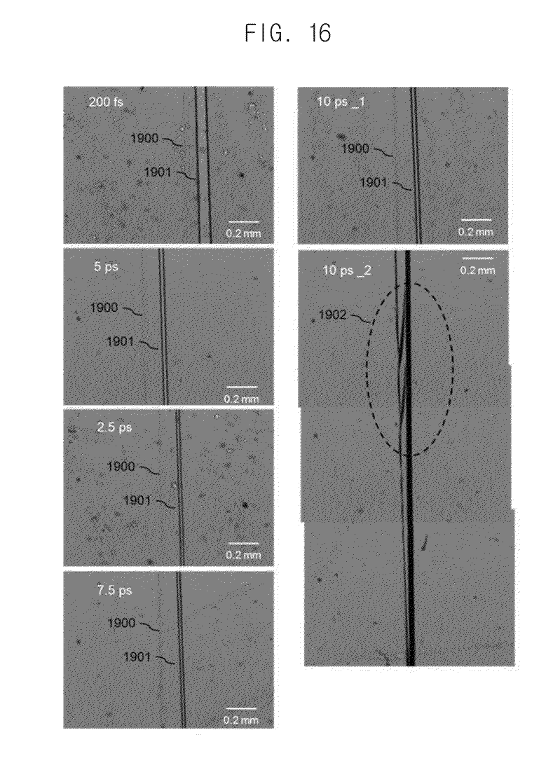

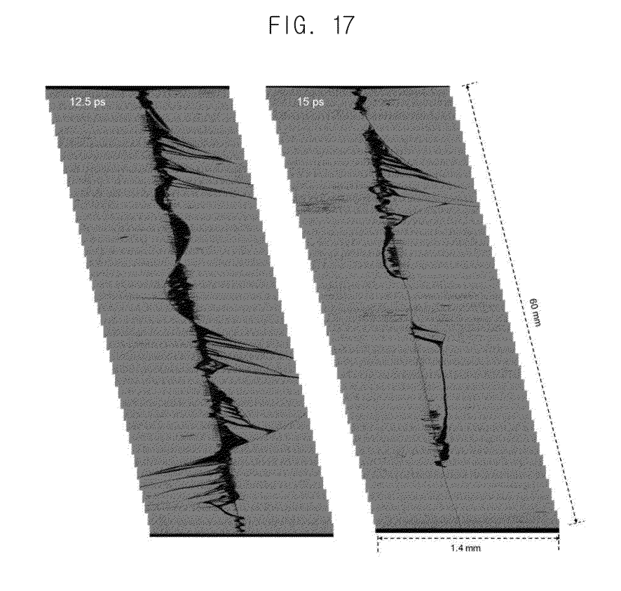

FIGS. 16 and 17 are diagrams illustrating enlarged photographs of cutting result when the strengthened glass of FIG. 6 is cut using lasers of various pulse widths. Referring to FIG. 16 illustrating the enlarged photographs of FIG. 15, the cutting processes with the pulse widths from 200 fs to 7.5 ps are successful but the cutting result with the pulse width of 10 ps shows the unstable cutting portion.

Referring to FIG. 17 illustrating the cutting results with the pulse widths of 12.5 ps and 15 ps, it has been verified that the normal cutting cannot be performed because of many cracks centered on the laser illumination line. The undesired cracks increase as the pulse width increases. When cutting the specimen is tried using the pulse width of 17.5 ps, the nonlinear absorption is weakened due to the broad pulse width and low peak output and thus cutting or crack is not observed.

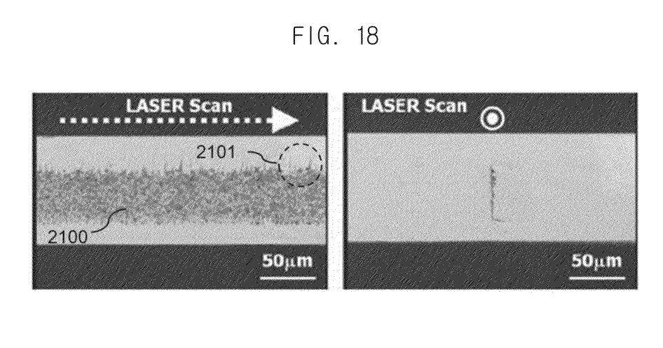

FIG. 18 is a diagram illustrating a cut surface that is obtained when a silicon wafer is cut using a stealth dicing method of Hamamatsu Company. The reformed surface 2100 is formed in the silicon wafer and then physical force is applied to cut the silicon wafer. In the stealth dicing method of FIG. 18, the silicon wafer has been illuminated by the laser having the central wavelength corresponding to the transmission band of silicon, the pulse energy of several μJ and the pulse width of about 100 ns.

As illustrated in the photographs of FIG. 18, many seed cracks 2101 exist near the reformed surface 2100. The rough reformed surface and the seed cracks cause damages of the specimen when a weight is imposed to the specimen, which has to be improved. The stealth dicing method of cutting the specimen by generating the seed crack from the reformed surface and developing it in the vertical direction cannot avoid such damages by the weight.

In contrast, because the crack may be propagated maintaining the offset from the laser illumination line in the method of the present invention, the heat affected zone due to laser illumination may be controlled not to be exposed to the cut surface. When manufacturing a specimen in a form of a closed loop, the heat affected zone may be placed out of the closed loop and thus the problems due to the heat affected zone may be solved.

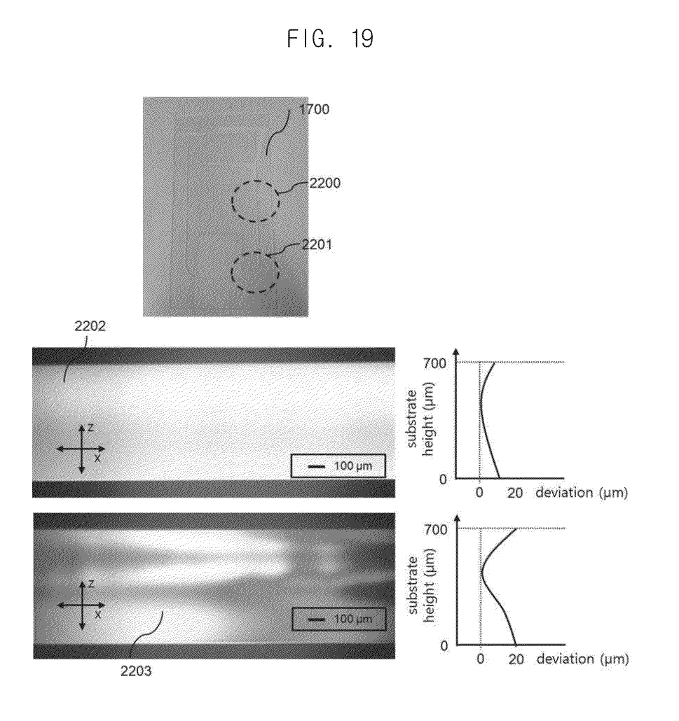

The cut surface of the transparent specimen, which is processed by the processing method of the present invention, is illustrated in FIG. 19.

FIG. 19 is a diagram illustrating a cut surface that is obtained when the strengthened glass of FIG. 6 is cut using a method of processing a transparent specimen according to an example embodiment.

FIG. 19 illustrates a cut portion 2200 of a straight line of the processed specimen 1700, a cut portion 2201 of a curved line of the processed specimen 1700 and enlarged photographs of the corresponding cut surfaces 2202 and 2203. As illustrated in FIG. 19, the maximum deviation of the crack in the cut surface is about 20 μm, that is, the cut surface forms a mirror surface, and thus there is no probability of seed crack development.

The peak output for propagating the crack at the offset distance from the movement line of the focal point of the pulse laser beam may be varied depending on a type and a thickness of a specimen. If the peak output of the laser beam is high enough to cause the nonlinear absorption actively in the specimen, the processing method of the present invention may be implemented regardless of the type and the thickness of the specimen.

The average output of the pulse laser beam may be set in a range such that the peak output of the pulse laser beam may be sufficient to propagate the crack at the offset distance from the movement line of the focal point of the pulse laser beam. The economic cost and the technical difficulty are increased to implement the average output higher than 1 kW, and thus the average output of the pulse laser beam may be between 0.1 W and 1 kW.

The repetition rate of the pulse laser beam may be set to an arbitrary value in a range satisfying the condition that the crack may be propagated at the offset distance from the movement line of the focal point of the pulse laser beam. The economic cost and the technical difficulty are increased to implement the repetition rate lower than 0.1 MHz or higher than 250 MHz, and thus the repetition rate of the pulse laser beam may be between 0.1 MHz and 250 MHz.

In association with ranges of the peak output, the average output and the repetition rate of the pulse laser beam, experiments to cut the transparent specimen have been performed such that the pulse width of the laser is fixed and the average output and the repetition rate are varied, so as to search the proper ranges of the average output and the repetition rate of the pulse laser beam where the crack may be propagated at the offset distance from the movement line of the focal point of the pulse laser beam.

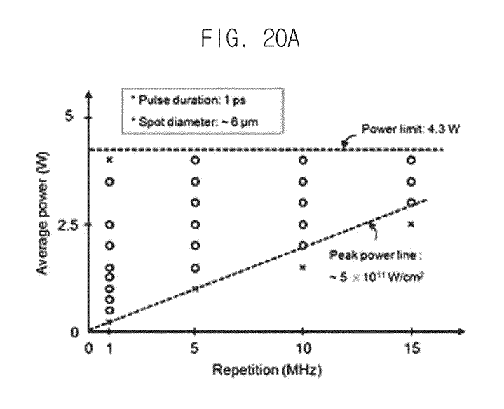

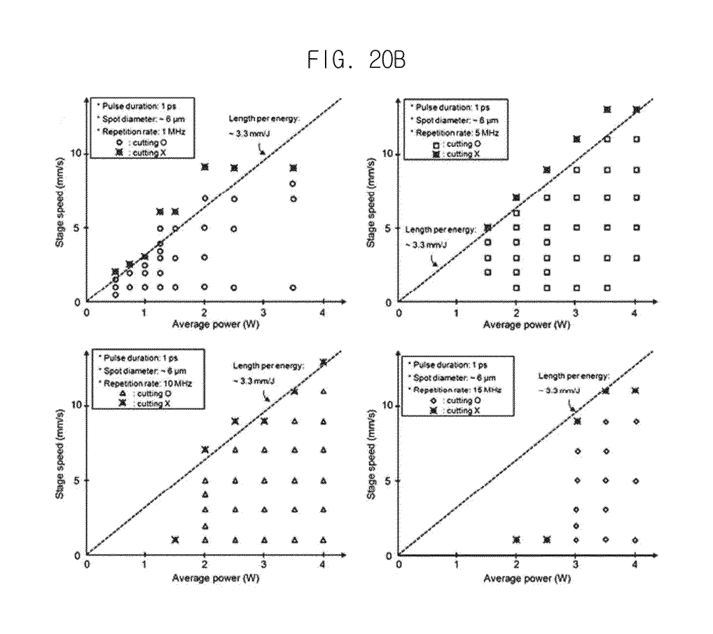

FIGS. 20A and 20B are diagrams illustrating cut positions and limiting conditions with respect to various combinations of an average power, a stage speed and a repetition rate, where a strengthened glass (IOX-FX specimen, Soda-lime glass) having a strengthened width of 0.02 mm and a surface strength of 700 MPa is cut using a pulse laser having a pulse width of about 1 ps.

FIG. 20A illustrates the cutting results by varying the repetition rate and the average output of the laser with the pulse width of 1 ps and the radius of the focused point is about 3 μm. As illustrated in FIG. 20A, the peak power line of about 5*1011 W/cm² determines success and fail of processing. The peak output required for the specimen processing represents the value just before the laser pulse is incident in the specimen. The region of successful cutting in FIG. 20A corresponds to the region having the probability of cutting success higher than 95%. From this result, it may be determined that the minimum peak output for successful cutting is 1011 W/cm².

In the region below the peak power line, the probability of cutting success is relatively low because the nonlinear absorption is not active even though the laser is illuminated to the specimen. As the peak power is lowered, generation of the seed crack is retarded and the crack is not propagated even though it is generated. The tendency may be maintained for various kinds of the brittle substrate, but the peak power value for the nonlinear absorption may be varied. The output limit used in the experiments is about 8.5 W.

FIG. 20B illustrates the cutting results by varying the stage velocity using the pulse laser of the repetition rate of 1 MHz, 5 MHz, 10 MHz and 15 MHz. In graphs of FIG. 20B, each line of a particular slope is found, where the unit of the slope is mm/J representing an inverse of supplied energy per unit length. When the pulse repetition rate is 1 MHz, cutting successes are observed in the condition of relatively low average output and repetition rate. When the average output is increased to about 4 W, undesired cracks are generated around the laser illumination line and thus cutting success is reduced. The above mentioned line of 3.3 mm/j is still found even though the repetition rate is increase gradually from 1 MHz to 15 MHz. In case of the pulse repetition rate of 15 MHz, the nonlinear absorption does not occur at the low average output under 2.5 W and cutting success is observed if the average output is increased to about 3 W.

The cutting results have not been observed with the repetition rate over 15 MHz and the average output over 4.3 W, because of limits of the experiment system. When analyzed from the results of FIGS. 20A and 20B, it is expected that the cutting speed may be enhanced by increasing the repetition rate and the average output, because the same cutting conditions such as a pulse energy, a pulse peak output, incident energy per unit area of the specimen, incidence interval between pulses, etc. may be implemented even though the average output and repetition rate of the pulse laser and the stage velocity are increased in the same rate.

The velocity of the focal point or the transparent specimen may be between 0.1 mm/sec and 1000 mm/sec. In general, the conditions such as the pulse energy, the repetition rate, the peak output, etc. for the specimen processing may be changed depending on the thickness and kind of the specimen, the shape of the cut line, the radius of curvature in case of the curved processing, the tensile stress in the specimen, etc. Also the relative velocity contributes to the processing conditions, and it is understood from FIGS. 20A and 20B that the cutting speed may be enhanced as the repetition rate and the average output are increased.

The velocity of the focal point may be between 0.1 mm through 1000 mm in the typical condition. If the velocity of the focal point is further increased, the crack is not generated or the crack cannot catch up with the movement of the focal point. In contrast, if the velocity of the focal point is further decreased, productivity is lowered and the crack line may deviate from the movement line of the focal point and the specimen may be broken because the number of the pulses per unit time and unit area is increase excessively.

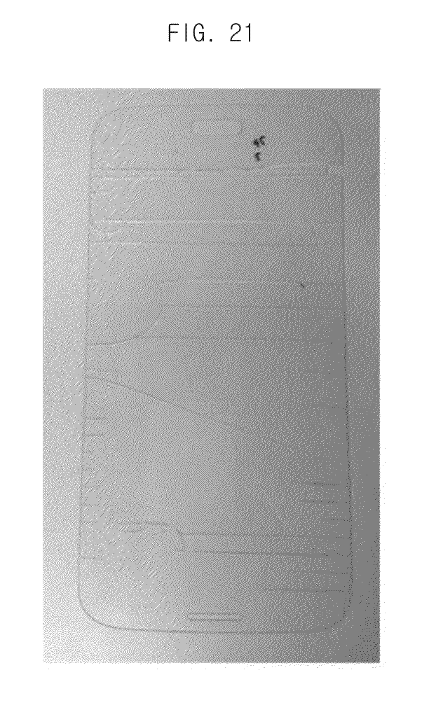

The method of processing the specimen according to example embodiments may be applied to the commercial compressed-strengthened glass. FIG. 21 is a diagram illustrating a cutting result of a gorilla 2 glass specimen using a method of processing a transparent specimen according to an example embodiment.

The gorilla 2 glass has a thickness of about 600 μm and a strength higher by several ten percents than the other strengthened glass. This glass is widely used in mobile devices because of the low price in addition to the excellent surface strength. However, there is no solution to cut the glass using laser and thus processing of the glass has been performed such that an entire specimen is cut and polished before the strengthening process and the cut portions are strengthened respectively. In contrast, the gorilla 2 glass can be cut successfully using the method according to example embodiments, which proves an excellent effect of the present invention.

According to example embodiments, the movement line of the focal point may begin not from an edge of the transparent specimen but from inside the transparent specimen so that the crack for processing of the transparent specimen may be generate inside the transparent specimen.

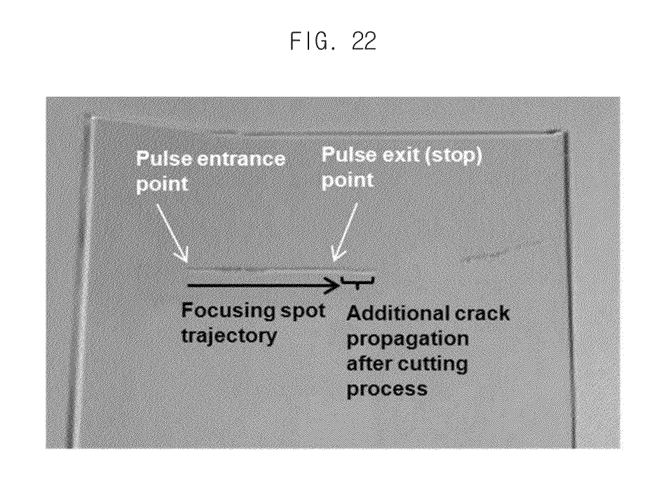

In general, the generation of the crack is easy if the movement lone of the focal point passes through an edge of the transparent specimen because of discontinuity of reaction and abrupt change of stress, but the generation of the crack is difficult if the focal point begins to move from inside the transparent specimen. FIG. 22 is a diagram illustrating a crack that is generated when a pulse entrance point and a pulse exit point are positioned inside a transparent specimen. The strengthened glass (IOX-FX specimen, Soda-lime glass) having a thickness of 700 μm is cut using the pulse laser having a central wavelength of 1030 nm, a repetition rate of 5 MHz, an average output of 2.4 W and a pulse width of 200 femtoseconds. FIG. 22 shows the result when the focal point is formed in a depth of 650 μm into the specimen and the focal point begins and stops inside the specimen.

According to example embodiments, a dicing device of processing a transparent specimen, includes, a laser source, a focusing system, a three-dimensional moving stage system, a crack-direction control unit and a controller. The laser source includes a laser resonator configured to generate a pulse laser beam having a pulse width of 10 femtoseconds through 10 picoseconds at a final output terminal, where a central wavelength of the pulse laser beam corresponds to a transmission band of the transparent specimen. The focusing system includes at least one mirror and at least one lens configured to focus the pulse laser beam from the laser source. The three-dimensional moving stage system moves the transparent specimen in an X-direction, a Y-direction and a Z-direction such that a crack is formed and propagated in the transparent specimen by a relative movement of the focused pulse laser beam with respect to the transparent specimen. The crack-direction control unit adjusts a propagation direction of the crack by controlling a temperature distribution in a neighboring region of a focal point to one side direction from a movement line of the focal point or in a neighboring region of the focal point to another side direction from the movement line of the focal point. The controller controls the laser source, the focusing system, the three-dimensional moving stage system and the crack-direction control unit. The crack includes a portion that is generated and propagated on the transparent specimen at a distance from the movement line of the focal point.

In some example embodiments, as described above, the crack may include a portion that is generated and propagated on the transparent specimen along a line connecting points corresponding to peak maximum stresses due to temperature gradient around the focal point in the transparent specimen.

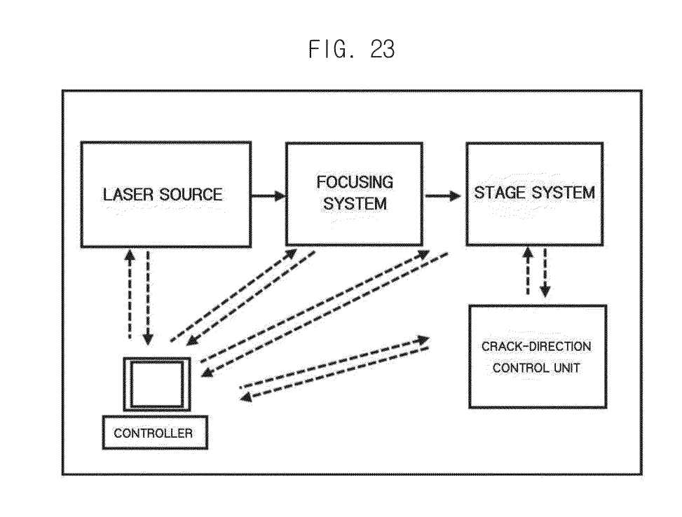

FIG. 23 is a block diagram illustrating a dicing device of processing a transparent specimen according to example embodiments.

The dicing device may generate the pulse laser beam having the pulse width of 10 femtoseconds through 10 picoseconds at the final output terminal and the central wavelength of the pulse laser beam corresponds to a transmission band of the transparent specimen.

The laser source is an ultrafast laser system that further includes a pulse stretcher configured to provide a pulse in the laser resonator, a pulse amplifier configured to amplify the stretched pulse, a pulse compressor configured to compress the amplified pulse and a pulse controller configured to control characteristics of the compressed pulse.

For example, a pulse train having a narrow pulse width of several hundred femtoseconds may be generated though a method such that a pulse is stretched and amplified using an amplifying system of a chirped pulse amplification (CPA) type and then the pulse is compressed again.

The desired feature may be added to the generated pulse by the pulse controller. For example, the pulse train may pass through only a desired time band, the spatial shape of the pulse wave front may be changed using a combination of a lens and a mirror, the polarization of the pulse may be controlled using various kinds of wave plates and the intensity of the laser may be controlled using a combination of a filter, a polarization beam splitter, a wave plate, etc.

In general, the spatial shape of the pulse wave front of the pulse laser beam may be a Gaussian shape, but the spatial shape of the pulse wave front may be changed to a ellipse shape using a combination of a lens and a mirror. If the pulse of the ellipse shape is generated and the elliptic pulse is illuminated to the transparent specimen, the tendency of the generation and propagation of the crack is closely related with the axis of the ellipse. Using this, the characteristics of the crack inducing the beam waist may be improved and/or the propagation direction of the crack may be adjusted.

In addition, if the axis of the ellipse is set to have a predetermined angle with respect to the movement direction of the beam waist, the cut surface may have a periodic pattern of a stripe as well as the cut surface is formed along movement path of the beam waist.

When the strengthened glass is processed using the ultrafast laser system, the average output of the laser beam may be between 0.1 W through 1 kW. In addition, the repetition rate of the pulse may be implemented in the range of 0.1 through 250 MHz using a laser resonator based on an optical fiber.

In general, a pulse train having a pulse width under several ten picoseconds and a repetition rate over several ten MHz may be generated by a mode-locking laser resonator, and the mode-locking laser resonator may be divided into a bulk type and an optical fiber type. The bulk type resonator includes a mirror, a lens and an amplifying crystal while most of the amplification media and the optical path are replaced with the optical fiber in case of the fiber type resonator. The bulk type laser may be represented by the Ti:Sapphire femtosecond laser that may implement a high power and good pulse characteristics but lacks scalability and has a low efficiency due to difficulty in direct diode laser pumping, and problems of optical arrangement and maintenance due to system complexity.

In contrast, the fiber type laser has advantages of adaptability to industry because it is insensitive to environmental changes such as temperature change and vibration and it does not require an addition arrangement in case of long-term usage. However, the fiber type laser has disadvantages such that the pulse shape is asymmetric and the pulse width is broadened because the pulse is affected in the optical fiber resonator by the high-order dispersion of the optical fiber.

The laser resonator based on an optical fiber has been manufactured to implement the pulse of the high repetition rate required for the example embodiments, and the stable pulse having a pulse width of about 200 fs.

The pulse repetition rate is determined typically by the repetition rate of the laser resonator, and typical resonator has the repetition rate of about 30 through 250 MHz. If the obtained repetition rate is lower, the repetition rate may be increase to about several MHz by increasing the length of the optical fiber and compensating for the nonlinearity and dispersion phenomena in the optical fiber. The low repetition rate under several Hz may be implemented by applying pulse picker to a post portion of the resonator.

If the high average output is required due to the kind of the specimen, internal stress distribution, etc., chirped pulse amplification may be used to obtain high power with the same pulse width. The chirped pulse amplification system includes a pulse stretcher, an amplifier and a compressor. While passing the pulse stretcher, the frequency components forming the pulse are expanded along the time axis by the dispersion difference between the frequencies and thus the peak output may be lowered to prevent optical damage or pulse degradation that may be caused by the high peak output. The pulse is amplified through the amplifier and is compressed and returns to the original pulse width through the compressor.

The output wavelength of the pulse laser may be between 300 nm and 3000 nm. The laser pulse generated in the laser resonator may be controlled by the pulse stretcher, the amplifier and the compressor to have the desired properties of the final laser beam.

The pulse laser beam focused inside the strengthened glass substrate may have a peak power density higher than 1011 W/cm2. The dicing device according to example embodiments includes the focusing system including at least one mirror and at least one lens configured to focus the pulse laser beam from the laser source. The focusing system may transfer the pulse having the characteristics desired by the user to the stage system through the mirrors and the lenses. The laser beam may be focused into the diameter under several μm by the focusing lens having 5 magnification to 100 magnification and the desired peak power density may be obtained finally to process the specimen.

To form a seed crack in the specimen, a PZT actuator may be established to the focusing lens or the object lens and the depth-directional modulation of the focal point may be adjusted using the PZT actuator. In addition, the depth direction of the focal point into the specimen may be adjusted by controlling collimation condition of the laser beam.

The dicing device according to example embodiments includes the three-dimensional moving stage system configured to move the transparent specimen in the X-direction, the Y-direction and the Z-direction such that the crack may be formed and propagated in the transparent specimen by the relative movement of the focused pulse laser beam with respect to the transparent specimen. In other example embodiments, the focused laser beam instead of the transparent specimen may be moved in the X-direction, the Y-direction and the Z-direction, which are perpendicular to each other.

The crack-direction control unit may adjust the propagation direction of the crack or the distance of the crack from the movement line of the focal point by controlling the temperature distribution in the neighboring region of the focal point to one side direction from the movement line of the focal point or in the neighboring region of the focal point to another side direction from the movement line of the focal point. For example, the cooling process, the heating process or the combination thereof may be performed with respect to the neighboring portions.

More specifically, the crack-direction control unit may heat or cool a portion of the specimen by spraying the cooled gas, directly heating or providing radiation heat to the neighboring region of the focal point to one side direction from the movement line of the focal point or to the neighboring region of the focal point to another side direction from the movement line of the focal point. The aerosol, the cooling gas may be sprayed around the focal point or the radiation heat may be provided by illumination a light to the transparent specimen.

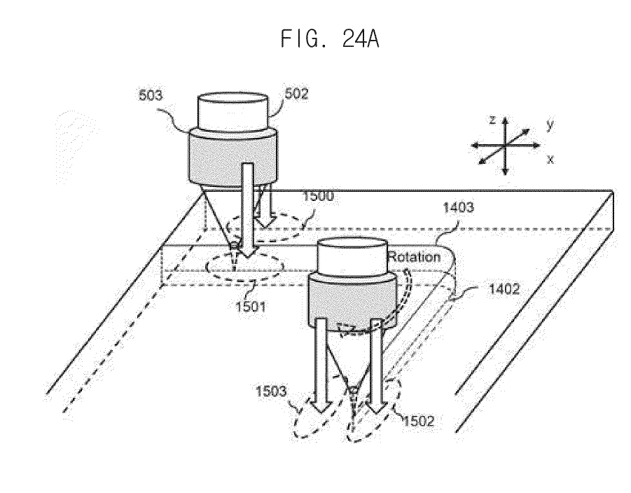

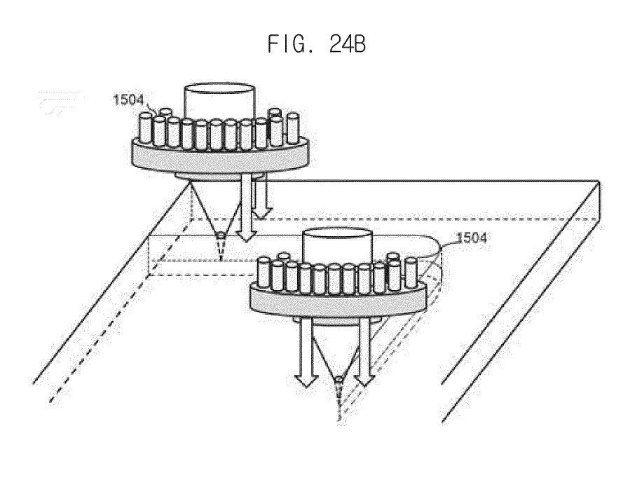

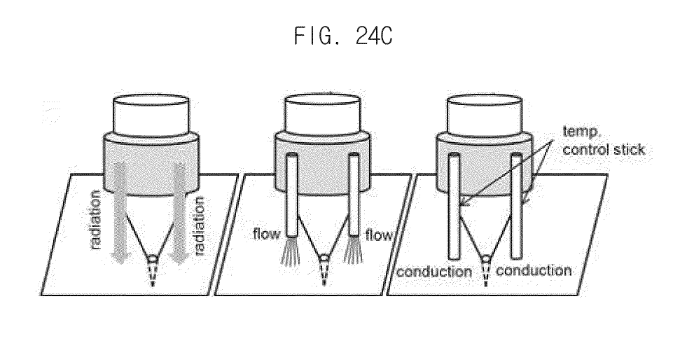

FIGS. 24A, 24B and 24C are diagrams for describing an example embodiment of a crack-direction control unit for cooling or heating left and right side portions 1500 and 1501 with respect to a movement line 1402 of a focal point.

The crack-direction control unit may cool or heat the transparent specimen using typical methods of conduction, convection or radiation, for example, using various solutions such as a cooling rod, a coolant, a heating lamp, a laser, etc.

As illustrated in FIGS. 24A and 24B, the crack-direction control unit is disposed at the illumination position on the transparent specimen. When the cutting line is a curved line, the crack-direction control unit may rotate while moving along the cut line to control the temperature continuously.

As illustrated in FIG. 24B, the crack-direction control unit may include a plurality of heating units and/or cooling units, to finely control the temperature of the transparent specimen so that the rotating part in FIG. 24A may be omitted. FIG. 24C illustrates example of controlling the temperature by using the radiation heat, spraying the heated or cooled gas and using physical contact of the heated or cooled stick with the transparent specimen.

The area of the temperature control portions 1500 and 1501 may be very wide even to the entire surface of the transparent specimen. When the processing is performed along a cut line with a small radius of curvature, the area of the temperature control portions 1500 and 1501 may be narrow and disposed near the laser illumination line. The temperature control portions 1500 and 1501 are placed to the left and right side directions from the laser illumination line and thus also the temperature control portions 1500 and 1501 have to be rotated when the cut line includes a curved line. As described above, the crack-direction control unit may include a plurality of heating units and/or cooling units that are arranged in a ring shape centered on the focal point, and the units may be turned on or off respectively.

In some example embodiments, the crack-direction control unit may heat or cool a portion of the transparent specimen by contacting a heated or cooled plate to the neighboring region of the focal point to the one side direction or to the neighboring region of the focal point to the another side direction.

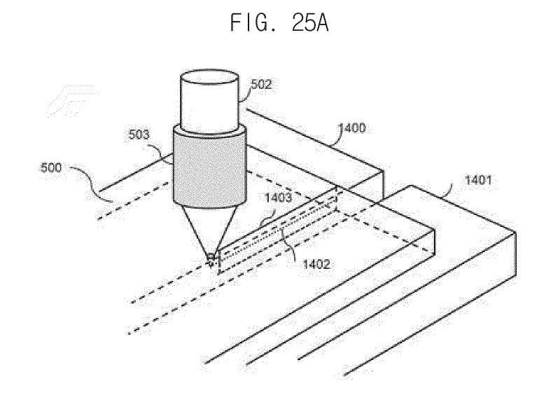

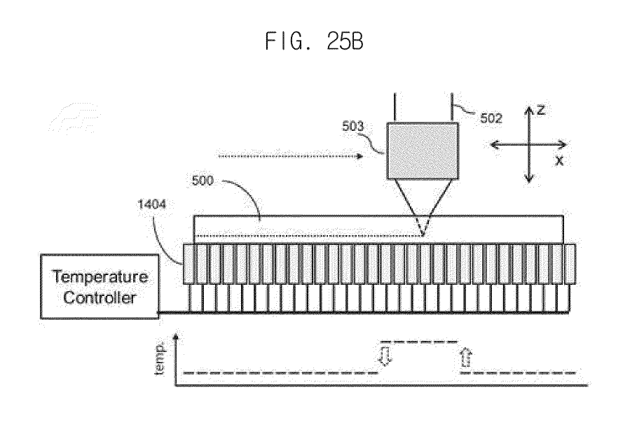

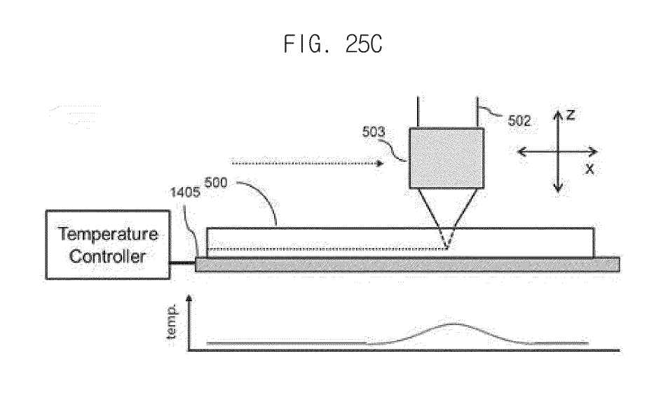

FIGS. 25A, 25B and 25C are diagrams for describing an example embodiment of a crack-direction control unit including heat bottom plates 1400 and 1401 for forming temperature gradient by differently controlling temperature of left and right side portions with respect to the movement line 1402 of the focal point. FIGS. 25A and 25B illustrate an example of the heat bottom plates for straight line processing and the shape of the plates may be determined depending on the pattern of the laser illumination line or the movement line of the focal point. As illustrated in FIG. 25A, a temperature control device may be attached to the heat bottom plates to form fixed temperature gradient on the heat bottom plates, respectively. When the temperature gradient is required to be varied, the heat bottom plate may include a plurality of segments that may be controlled independently as illustrated in FIG. 25B or the heating film may be used to heat or cool continuously along the movement line of the focal point as illustrated in FIG. 25C.

In some example embodiments, the crack-direction control unit may include an additional laser for providing thermal energy to the neighboring region of the focal point to the one side direction or to the neighboring region of the focal point to the another side direction, thereby controlling the temperature distribution around the focal point.

The thermal stress to both side directions from the focal point may be controlled by controlling the temperature distribution around the focal point, and thus the propagation of the crack may be controlled such that the crack follows the moving focal point with maintaining the value and sign of the offset distance, or with changing the value and sign of the offset distance as desired.

In some example embodiments, the dicing device may further include an auto-focusing system configured to position the focal point of the focused pulse laser beam at a desired location inside the transparent specimen between an upper surface and a bottom surface of the transparent specimen to control the focal point in real time.

The controller in the dicing device may control the laser source, the focusing system, the three-dimensional moving stage system and the crack-direction control unit and the operations of the dicing device may be monitored by the controller. For example, the controller may monitor the location of the focal point, the interval between the crack line and the laser illumination line, the velocity of the moving crack, etc. and required information may be extracted based on the monitoring results.

Even though FIG. 23 illustrates one controller for controlling all components such as the laser source, the focusing system, the three-dimensional moving stage system and the crack-direction control unit, the dicing device may include two or more controllers such that one controller controls a selected portion of the laser source, the focusing system, the three-dimensional moving stage system and the crack-direction control unit and another controller controls another selection portion of the laser source, the focusing system, the three-dimensional moving stage system and the crack-direction control unit.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### DESCRIPTION OF REFERENCE NUMERALS

500: transparent specimen
501: focal point of laser inside the transparent specimen
502: ultrafast pulse laser
503: focusing lens (object lens)
504: position of negative offset (−δ) among two positions of local maximum temperature gradient along R-R′ line
505: position of positive offset (+δ) among two positions of local maximum temperature gradient along R-R′ line
600: upper surface of transparent specimen
601: bottom surface of transparent specimen
602: relative motion path of ultrafast pulse laser with respect to specimen
603: movement line of focal point of ultrafast pulse laser in specimen
604: crack line propagating in parallel with movement line of focal point at positive offset (+δ) from the movement line of focal point
605: crack line propagating in parallel with movement line of focal point at negative offset (−δ) from the movement line of focal point
606: direction or position of negative offset (−δ) among two positions of local maximum temperature gradient along A-A′ line
607: direction of position of positive offset (+δ) among two positions of local maximum temperature gradient along A-A′ line
700: crack start position after seed crack is formed by incidence of ultrafast pulse laser, propagating along laser illumination line with negative offset (−δ) from the laser illumination line
701: illumination line of ultrafast pulse laser
702: propagation line of crack
703: crack start position after seed crack is formed by incidence of ultrafast pulse laser, propagating along laser illumination line with positive offset (+δ) from the laser illumination line
704: illumination line of ultrafast pulse laser
705: propagation line of crack with positive offset (+δ) from laser illumination line
706: portion that crack propagates changing offset sign
707: crack line largely apart from laser illumination line due to inertia of changing offset sign
800: illumination line of ultrafast pulse laser
801: propagation line of crack
900: crack start position after seed crack is formed by incidence of ultrafast pulse laser, propagating along laser illumination line with negative offset (−δ) from the laser illumination line
901: illumination line of ultrafast pulse laser
902: propagation line of crack
1000: cross region where crack shifts from positive offset (+δ) with respect to laser illumination line to negative offset (−δ) with respect to laser illumination line.
1001: cross region where crack shifts from negative offset (−δ) with respect to laser illumination line to positive offset (+δ) with respect to laser illumination line.
1100: illumination line of ultrafast pulse laser of normal incidence
1101: crack line propagating with positive offset (+δ) from laser illumination line
1102: crack line propagating with negative offset (−δ) from laser illumination line
1103: illumination line of ultrafast pulse laser of oblique incidence
1104: crack line propagating with relatively small offset from laser illumination line
1200: laser illumination line of positive-direction oblique incidence
1201: crack line propagating with positive offset (+δ) from laser illumination line of positive-direction oblique incidence
1202: laser illumination line of negative-direction oblique incidence
1203: crack line propagating with negative offset (−δ) from laser illumination line of negative-direction oblique incidence
1204: laser illumination line of positive-direction oblique incidence (12 cm in total)
1205: crack line propagating with positive offset (+δ) from laser illumination line of positive-direction oblique incidence (12 cm in total)
1300: region to positive direction with respect to laser illumination line in which cooling and/or heating is performed to control propagation characteristics of crack
1301: region to negative direction with respect to laser illumination line in which cooling and/or heating is performed to control propagation characteristics of crack
1302: graph of residual tensile stress distribution without heat control when left and right regions are symmetric with respect to laser illumination line
1303: graph of residual tensile stress distribution with heat control of heating 1300 portion in FIG. 12 or cooling 1301 portion in FIG. 12
1304: position of maximum residual tensile stress based on heat control
1400, 1401: heat bottom plates for forming temperature gradient in neighboring regions to both side directions from laser illumination line
1402 illumination line of ultrafast pulse laser
1403: propagation line of crack
1500, 1501: regions heated or cooled to control propagation line of crack
1600: illumination line of ultrafast pulse laser
1601: propagation line of crack
1602: illumination line of ultrafast pulse laser
1603: propagation line of crack
1700: specimen cutting result including combination of straight line and curved line
1701: laser illumination line in form of curved line
1702: crack line propagated maintaining positive offset (+δ) from illumination line of ultrafast pulse laser
1800: cutting result by laser having pulse width of 200 fs
1801: cutting result by laser having pulse width of 2.5 ps
1802: cutting result by laser having pulse width of 5 ps
1803: cutting result by laser having pulse width of 7.5 ps
1804: cutting result by laser having pulse width of 10 ps
1805: cutting result by laser having pulse width of 12.5 ps
1806: cutting result by laser having pulse width of 15 ps
1807: cutting result by laser having pulse width of 17.5 ps
1900: illumination line of ultrafast pulse laser
1901: propagation line of crack
1902: unstable crack growth in laser illumination line
2100: reformed surface of Si wafer formed by illumination of nanosecond pulse laser
2101: micro cracks generated by reformed surface
2200: cut portion of straight line obtained through present invention
2201: cut portion of curved line obtained through present invention
2202: cut surface of straight line obtained through present invention
2203: cut surface of curved line obtained through present invention

1. A method of processing a transparent specimen, comprising:
forming a focal point by generating and focusing an ultrafast pulse laser beam from a laser source, the pulse laser beam having a pulse width approximately between 10 femtoseconds to 10 picoseconds and a central wavelength of the pulse laser beam corresponding to a transmission band of the transparent specimen;
transferring energy to an inside of the transparent specimen using the focused pulse laser beam by positioning the focal point of the pulse laser beam between an upper surface and a bottom surface of the transparent specimen; and
generating and propagating a crack by relatively moving the focal point or the transparent specimen along a cut line of a desired shape such that the crack includes a portion that is propagated on the transparent specimen at a distance from a movement line of the focal point.

2. A method of processing a transparent specimen according to claim 1,
wherein generating and propagating a crack by relatively moving the focal point or the transparent specimen along a cut line of a desired shape such that the crack includes a portion that is propagated on the transparent specimen at a distance from a movement line of the focal point further includes maintaining a positive offset distance from a movement line of the focal point to a first side direction of the transparent specimen or maintaining a negative offset distance from the movement line of the focal point to a second side direction of the transparent specimen.

3. The method of claim 1, wherein generating and propagating a crack by relatively moving the focal point or the transparent specimen along a cut line of a desired shape further includes, at least once, propagating the crack apart from the movement line to one side direction of the transparent specimen, passing the crack through the movement line of the focal point, and propagating the crack apart from the movement line to another side direction of the transparent specimen.

4. The method of claim 1, wherein generating and propagating a crack by relatively moving the focal point or the transparent specimen along a cut line of a desired shape further includes propagating the crack apart from the movement line to one side direction of the transparent specimen without propagating the crack apart from the movement line to another side direction of the transparent specimen.

5. The method of claim 1, wherein the transparent specimen is one selected from a glass substrate, a silicon substrate, a surface-strengthened glass substrate, a sapphire substrate, an SiC substrate, a GaN substrate, a ceramic substrate, a transparent substrate for an organic light-emitting diode (OLED) and a transparent polymer substrate for a flexible display.

6. The method of claim 1 or 2, wherein a propagating direction of the crack or the distance of the crack from the movement line of the focal point is adjusted when the crack is propagated by performing a cooling process, a heating process or a combination of the cooling process and the heating process in a neighboring region of the focal point to one side direction from the movement line of the focal point or in a neighboring region of the focal point to another side direction from the movement line of the focal point to control a temperature distribution around the focal point.

7. The method of claim 1, wherein a propagating direction of the crack or the distance of the crack from the movement line of the focal point is adjusted when the crack is propagated by adjusting at least one of a relative velocity between the focal point and the transparent specimen, a depth of the focal point into the transparent specimen, a peak output of the pulse laser beam, an average output of the pulse laser beam, a repetition rate of the pulse laser beam and an incident angle of the pulse laser beam with respect to the transparent specimen.

8. The method of claim 1, wherein a cut cross section of the processed transparent specimen by the crack propagation forms a mirror surface.

9. The method of claim 1, wherein the crack is propagated in a form of a straight line, a curved line or a combination of the straight line and the curved line.

10. The method of claim 1, wherein the crack is propagated forming a closed loop and a propagation line of the crack is surrounded by the movement line of the focal point to position the propagation line of the crack within the movement line of the focal point.

11. The method of claim 1, wherein the crack begins to be formed from inside the transparent specimen by beginning a movement of the focal point not from an edge of the transparent specimen but from inside the transparent specimen.

12. The method of claim 1, wherein the transparent specimen is a strengthened glass substrate and the pulse laser beam focused inside the strengthened glass substrate has a peak power density higher than 1011 W/cm².

13. The method of claim 1, wherein an average output of the pulse laser beam is between 0.1 W and 1 kW and a repetition rate of the pulse laser beam is between 0.1 MHz and 250 MHz.

14. The method of claim 1, wherein a velocity of the focal point or the transparent specimen is between 0.1 mm/sec and 1000 mm/sec.

15. The method of claim 1, wherein processing of the transparent specimen is completed by moving the pulse laser beam one time along the movement line of the focal point such that the transparent specimen is cut out or a portion of the transparent specimen is separated from another portion of the transparent specimen.

16. A method of processing a transparent specimen, comprising:
forming a focal point by focusing a pulse laser beam in an inside region between an upper surface and a bottom surface of the transparent specimen, a central wavelength of the pulse laser beam corresponding to a transmission band of the transparent specimen, the pulse laser beam having a pulse width of 10 femtoseconds through 10 picoseconds at a final output terminal;
moving the focal point along a cut line of a desired shape; and
generating and propagating a crack along a line connecting points corresponding to peak maximum stresses due to temperature gradient around the focal point in the transparent specimen.

17. A dicing device of processing a transparent specimen, comprising:
a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen;
a focusing system including at least one mirror and at least one lens configured to focus the pulse laser beam from the laser source;
a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen;
a crack-direction control unit configured to adjust a propagation direction of the crack by controlling a temperature distribution in a neighboring region of a focal point to one side direction from a movement line of the focal point or in a neighboring region of the focal point to another side direction from the movement line of the focal point; and
a controller configured to control the laser source, the focusing system, the three-dimensional moving stage system and the crack-direction control unit,
wherein the crack includes a portion that is generated and propagated on the transparent specimen at a distance from the movement line of the focal point.

18. The dicing device of claim 17, wherein the crack-direction control unit is configured to adjust a propagating direction of the crack or the distance of the crack from the movement line of the focal point when the crack is propagated by performing a cooling process, a heating process or a combination of the cooling process and the heating process in the neighboring region of the focal point to the one side direction from the movement line of the focal point or in the neighboring region of the focal point to the another side direction from the movement line of the focal point to control the temperature distribution around the focal point.

19. The dicing device of claim 17, wherein the laser source is an ultrafast laser system that further includes a pulse stretcher configured to provide a pulse in the laser resonator, a pulse amplifier configured to amplify the stretched pulse, a pulse compressor configured to compress the amplified pulse and a pulse controller configured to control characteristics of the compressed pulse.

20. The dicing device of claim 17, wherein when the transparent specimen includes a material of a compressed-strengthened glass, the pulse laser beam has a peak power density higher than 1011 W/cm².

21. The dicing device of claim 17, wherein an average output of the pulse laser beam is between 0.1 W and 1 kW and a repetition rate of the pulse laser beam is implemented between 0.1 MHz and 250 MHz using the laser resonator based on an optical fiber.

22. The dicing device of claim 17, wherein the focused pulse laser beam is moved in the X-direction, the Y-direction and the Z-direction instead of moving the transparent specimen.

23. The dicing device of claim 17, further comprising:
an auto-focusing system configured to position the focal point of the focused pulse laser beam at a desired location inside the transparent specimen between an upper surface and a bottom surface of the transparent specimen to control the focal point in real time.

24. The dicing device of claim 18, wherein the crack-direction control unit is configured to control the temperature distribution around the focal point such that the crack-direction control unit cools or heats a portion of the transparent specimen (i) by heating, spraying a cooled gas to or providing a radiant heat to the neighboring region of the focal point to the one side direction or to the neighboring region of the focal point to the another side direction, (ii) by contacting a heated or cooled plate to the neighboring region of the focal point to the one side direction or to the neighboring region of the focal point to the another side direction and (iii) by including an additional laser for providing thermal energy.

25. A dicing device of processing a transparent specimen, comprising:
a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen;
a focusing system including at least one mirror and at least one lens configured to focus the pulse laser beam from the laser source;
a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen;
a crack-direction control unit configured to adjust a propagation direction of the crack by controlling a temperature distribution in a neighboring region of a focal point to one side direction from a movement line of the focal point or in a neighboring region of the focal point to another side direction from the movement line of the focal point; and
a controller configured to control the laser source, the focusing system, the three-dimensional moving stage system and the crack-direction control unit,
wherein the crack includes a portion that is generated and propagated on the transparent specimen along a line connecting points corresponding to peak maximum stresses due to temperature gradient around the focal point in the transparent specimen.

26. A dicing device of processing a transparent specimen, comprising:
a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen;
a focusing system including at least one mirror and at least one lens configured to focus the pulse laser beam from the laser source;
a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen; and
a controller configured to control the laser source, the focusing system and the three-dimensional moving stage system,
wherein the crack includes a portion that is generated and propagated on the transparent specimen at a distance from a movement line of a focal point.

27. A dicing device of processing a transparent specimen, comprising:
a laser source including a laser resonator configured to generate a pulse laser beam having a pulse width of 10 femtoseconds through 10 picoseconds at a final output terminal, a central wavelength of the pulse laser beam corresponding to a transmission band of the transparent specimen;
a focusing system including at least one mirror and at least one lens configured to focus the pulse laser beam from the laser source;
a three-dimensional moving stage system configured to move the transparent specimen in an X-direction, a Y-direction and a Z-direction such that a crack is formed and propagated in the transparent specimen by a relative movement of the focused pulse laser beam with respect to the transparent specimen; and
a controller configured to control the laser source, the focusing system, the three-dimensional moving stage system and the crack-direction control unit,
wherein the crack includes a portion that is generated and propagated on the transparent specimen along a line connecting points corresponding to peak maximum stresses due to temperature gradient around a focal point in the transparent specimen.
